(19) United States
(12) Patent Application Publication
(10) Pub. No.: US 2017/0085890 A1
(43) Pub. Date: Mar. 23, 2017

(54) MULTI-LAYER VIDEO ENCODING METHOD AND MULTI-LAYER VIDEO DECODING METHOD USING PATTERN INFORMATION

(71) Applicant: SAMSUNG ELECTRONICS CO., LTD., Suwon-si (KR)

(72) Inventors: Byeong-doo CHOI, Suwon-si (KR); Jin-young LEE, Suwon-si (KR); Yong-jin CHO, Seoul (KR)

(73) Assignee: SAMSUNG ELECTRONICS CO., LTD., Suwon-si (KR)

(21) Appl. No.: 15/126,119

(22) PCT Filed: Mar. 16, 2015
(86) PCT No.: PCT/KR2015/002506

§ 371 Date: Sep. 14, 2016

Related U.S. Application Data
(60) Provisional application No. 61/953,156, filed on Mar. 14, 2014.

(51) Int. Cl. H04N 19/187; H04N 19/136; H04N 19/105

(52) U.S. Cl. CPC H04N 19/187; H04N 19/105; H04N 19/136

(57) ABSTRACT

Provided is a multi-layer video decoding method. The multi-layer video decoding method includes: obtaining, from a bitstream, dependency information indicating whether a first layer refers to a second layer; if the dependency information indicates that the first layer refers to the second layer, obtaining a reference picture set of the first layer, based on whether type information of the first layer and type information of the second layer are equal to each other; and decoding encoded data of a current image included in the first layer, based on the reference picture set.

### TECHNICAL FIELD

The inventive concept relates to multi-layer video encoding and decoding methods.

### BACKGROUND ART

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on a coding unit of a tree structure.

Image data of a spatial region is transformed into coefficients of a frequency region via frequency transformation. According to a video codec, an image is split into blocks having a predetermined size, discrete cosine transformation (DCT) is performed on each block, and frequency coefficients are encoded in block units, for rapid calculation of frequency transformation. Compared with image data of a spatial region, coefficients of a frequency region are easily compressed. In particular, since an image pixel value of a spatial region is expressed according to a prediction error via inter prediction or intra prediction of a video codec, when frequency transformation is performed on the prediction error, a large amount of data may be transformed to 0. According to a video codec, an amount of data may be reduced by replacing data that is consecutively and repeatedly generated with small-sized data.

A multi-layer video codec encodes and decodes a first layer video and at least one second layer video. Amounts of data of the first layer video and the second layer video may be reduced by removing temporal/spatial redundancy and layer redundancy of the first layer video and the second layer video.

### DETAILED DESCRIPTION OF THE INVENTION

### Technical Problem

According to an aspect of the inventive concept, there is provided multi-layer video encoding and decoding methods using type information of layers.

### Technical Solution

There is provided a multi-layer video decoding method including: obtaining, from a bitstream, dependency information indicating whether a first layer refers to a second layer; if the dependency information indicates that the first layer refers to the second layer, obtaining a reference picture set of the first layer, based on whether type information of the first layer and type information of the second layer are equal to each other; and decoding encoded data of a current image included in the first layer, based on the reference picture set.

### Advantageous Effects

By using efficient multi-layer video encoding/decoding methods using type information, the efficiency of encoding/decoding operations is improved.

### DESCRIPTION OF THE DRAWINGS

FIG. 1A is a block diagram of a multi-layer video encoding apparatus according to an embodiment.

FIG. 1B is a flowchart of a multi-layer video encoding method according to an embodiment.

FIG. 2A is a block diagram of a multi-layer video decoding apparatus according to an embodiment.

FIG. 2B is a flowchart of a multi-layer video decoding method according to an embodiment.

FIG. 3A illustrates an inter-layer prediction structure according to an embodiment.

FIG. 3B illustrates a multi-layer video according to an embodiment.

FIG. 4 illustrates disparity compensation according to an embodiment.

FIG. 5 illustrates a multi-layer prediction structure according to encoding/decoding methods using a temporal sub-layer.

FIG. 6 shows NAL units including encoded data of a multi-layer video according to an embodiment.

FIG. 7 illustrates a method of configuring a reference picture set and/or a reference picture list by using type information according to an embodiment.

FIG. 8 is a block diagram of a video encoding apparatus based on coding units of a tree structure, according to an embodiment.

FIG. 9 is a block diagram of a video decoding apparatus based on coding units of a tree structure, according to an embodiment.

FIG. 10 is a diagram for describing a concept of coding units according to an embodiment.

FIG. 11 is a block diagram of a video encoder based on coding units, according to an embodiment.

FIG. 12 is a block diagram of a video decoder based on coding units, according to an embodiment.

FIG. 13 is a diagram illustrating coding units and partitions, according to an embodiment.

FIG. 14 is a diagram for describing a relationship between a coding unit and transformation units, according to an embodiment.

FIG. 15 illustrates pieces of encoding information according to an embodiment.

FIG. 16 is a diagram of coding units according to an embodiment.

FIGS. 17, 18, and 19 are diagrams for describing a relationship between coding units, prediction units, and transformation units, according to an embodiment.

FIG. 20 is a diagram for describing a relationship between a coding unit, a prediction unit, and a transformation unit, according to encoding mode information of Table 2.

FIG. 21 is a diagram of a physical structure of a disc in which a program is stored, according to an embodiment.

FIG. 22 is a diagram of a disc drive for recording and reading a program by using the disc.

FIG. 23 is a diagram of an overall structure of a content supply system for providing a content distribution service.

FIGS. 24 and 25 are diagrams respectively of an external structure and an internal structure of a mobile phone to which a video encoding method and a video decoding method of the present disclosure are applied, according to an embodiment.

FIG. 26 is a diagram of a digital broadcasting system to which a communication system according to the present disclosure is applied.

FIG. 27 illustrates a network structure of a cloud computing system using a video encoding apparatus and a video decoding apparatus according to various embodiments of the present disclosure.

### BEST MODE

According to an aspect of the present disclosure, there is provided a multi-layer video decoding method including: obtaining, from a bitstream, dependency information indicating whether a first layer refers to a second layer; if the dependency information indicates that the first layer refers to the second layer, obtaining a reference picture set of the first layer, based on whether type information of the first layer and type information of the second layer are equal to each other; and decoding encoded data of a current image included in the first layer, based on the reference picture set.

The type information of the first layer may indicate whether an image included in the first layer is a depth image, and the type information of the second layer may indicate whether an image included in the second layer is a depth image.

The obtaining of the reference picture set of the first layer may include, if a value of the type information of the first layer and a value of the type information of the second layer are equal to each other, allowing pictures of the second layer to be included in the reference picture set of the first layer.

The decoding of the encoded data of the current image included in the first layer may include performing disparity compensation based on the reference picture set.

The type information of the first layer and the type information of the second layer may be obtained from the bitstream.

According to an aspect of the present disclosure, there is provided a multi-layer video encoding method including: generating dependency information indicating whether a first layer refers to a second layer; if the dependency information indicates that the first layer refers to the second layer, obtaining a reference picture set of the first layer based on whether type information of the first layer and type information of the second layer are equal to each other; and encoding a current image included in the first layer, based on the reference picture set.

The type information of the first layer may indicate whether an image included in the first layer is a depth image, and the type information of the second layer may indicate whether an image included in the second layer is a depth image.

The obtaining of the reference picture set of the first layer may include, if a value of the type information of the first layer and a value of the type information of the second layer are equal to each other, allowing pictures of the second layer to be included in the reference picture set of the first layer.

The encoding of the current image included in the first layer may include performing disparity compensation based on the reference picture set.

The multi-layer video encoding method may further include generating the type information of the first layer and the type information of the second layer.

According to an aspect of the present disclosure, there is provided a multi-layer video decoding apparatus including: an obtainer for obtaining, from a bitstream, dependency information indicating whether a first layer refers to a second layer; and a decoder, if the dependency information indicates that the first layer refers to the second layer, obtaining a reference picture set of the first layer, based on whether type information of the first layer and type information of the second layer are equal to each other, and decoding encoded data of a current image included in the first layer based on the reference picture set.

The type information of the first layer may indicate whether an image included in the first layer is a depth image, and the type information of the second layer may indicate whether an image included in the second layer is a depth image.

According to an aspect of the present disclosure, there is provided a multi-layer video encoding apparatus including: an encoder for generating dependency information indicating whether a first layer and a second layer are dependent upon each other, and if a value of the dependency information is 1, obtaining a reference picture set of the first layer based on whether type information of the first layer and type information of the second layer are equal to each other, and encoding a current image included in the first layer, based on the reference picture set.

The multi-layer video encoding apparatus may further include a bitstream generator for generating a bitstream including the dependency information, the type information of the first layer, and the type information of the second layer.

### MODE OF THE INVENTION

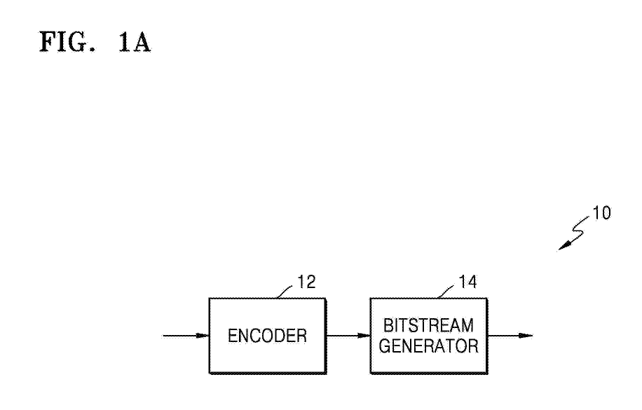

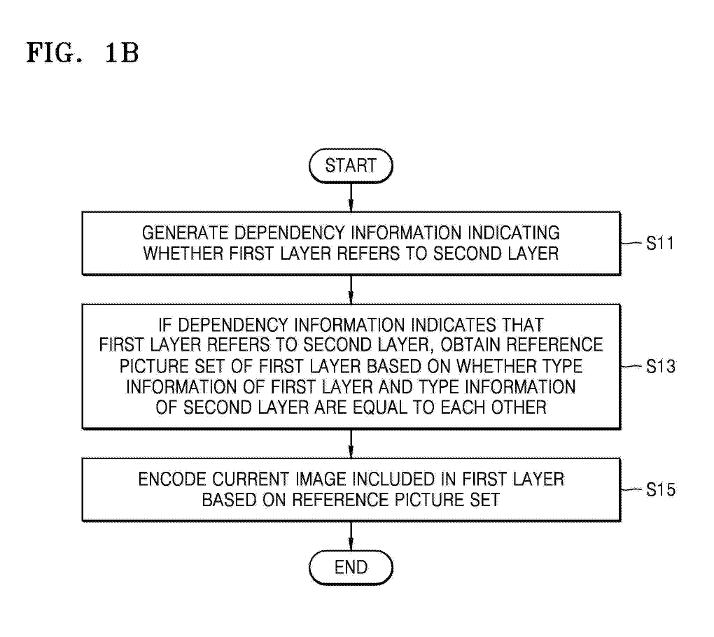

Hereinafter, with reference to FIGS. 1A through 7, a multi-layer video encoding technique and a multi-layer video decoding technique that use type information according to an embodiment will be described.

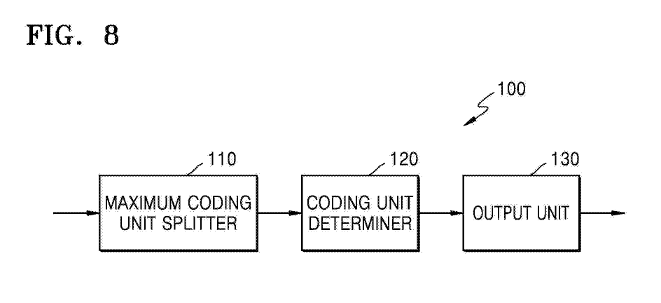

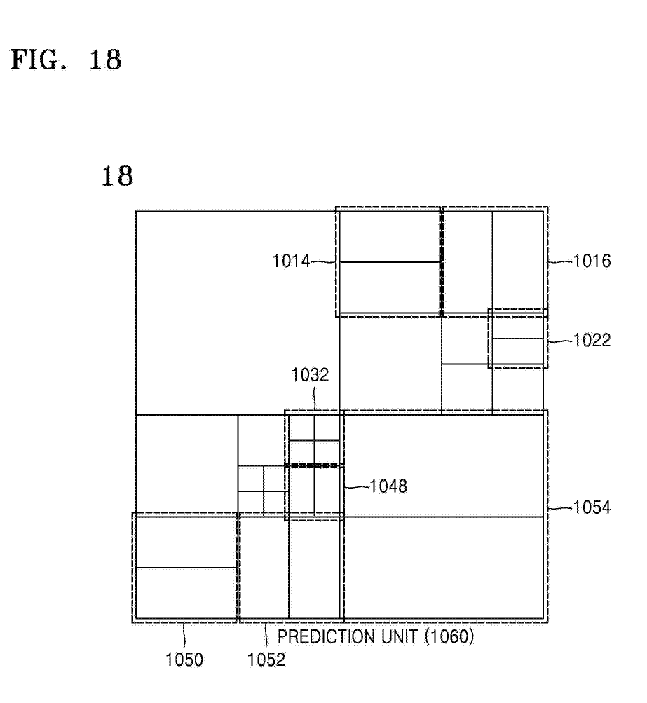

Also, with reference to FIGS. 8 through 20, a video encoding technique and a video decoding technique, which are based on coding units having a tree structure, according to embodiments applicable to the inter-layer video encoding and decoding techniques will be described.

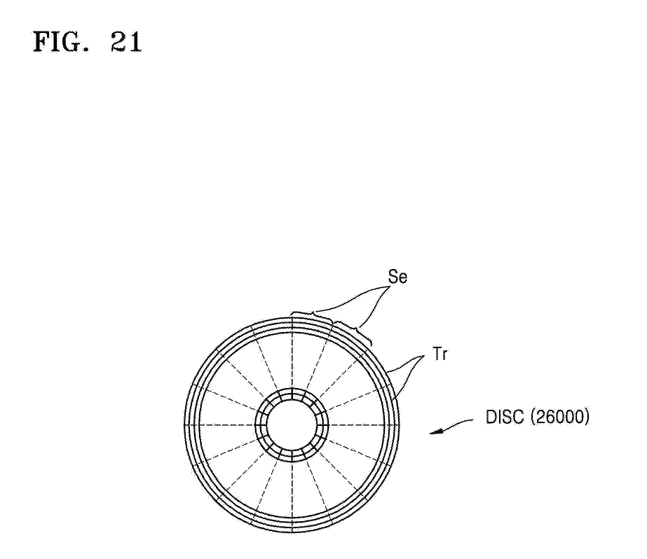

Also, with reference to FIGS. 21 through 27, embodiments to which the video encoding method and the video decoding method are applicable will be described.

Hereinafter, an ‘image’ may denote a still image or a moving image of a video, or a video itself.

Hereinafter, a ‘sample’ denotes data that is assigned to a sampling location of an image and is to be processed. For example, pixel values or residual of a block in an image of a spatial domain may be samples.

Hereinafter, a ‘current block’ may denote a block of an image to be encoded or decoded.

Hereinafter, a ‘neighboring block’ denotes at least one encoded or decoded block adjacent to the current block. For example, a neighboring block may be located at the top, upper right, left, or upper left of a current block. Also, a neighboring block may be a spatially-neighboring block or a temporally-neighboring block. For example, a temporally-neighboring block may include a block of a reference picture, which is co-located as a current block, or a neighboring block of the co-located block.

Hereinafter, a “layer image” denotes specific-view images or specific-type images. In a multiview video, one layer image indicates texture images or depth images which are input at a specific view. For example, in a three-dimensional (3D) video, each of a left-view texture image, a right-view texture image, and a depth image forms one layer image. That is, the left-view texture image may form a first layer image, the right-view texture image may form a second layer image, and the depth image may form a third layer image.

FIG. 1A is a block diagram of a multi-layer video encoding apparatus according to an embodiment.

Referring to FIG. 1A, the multi-layer video encoding apparatus 10 may include an encoder 12 and a bitstream generator 14.

The video encoding apparatus 10 according to an embodiment may classify a plurality of image sequences according to layers and may encode each of the image sequences according to a scalable video coding scheme, and may output separate streams including data encoded according to layers. The video encoding apparatus 10 may encode a first layer image sequence and a second layer image sequence to different layers.

For example, the encoder 12 may encode first layer images and output a first layer stream including encoding data of the first layer images. In addition, the encoder 12 may encode second layer images, and output a second layer stream including encoding data of the second layer images.

In addition, for example, according to a scalable video coding method based on spatial scalability, low resolution images may be encoded as first layer images, and high resolution images may be encoded as second layer images. An encoding result of the first layer images may be output as a first layer stream, and an encoding result of the second layer images may be output as a second layer stream.

The video encoding apparatus 10 according to an embodiment may express and encode the first layer stream and the second layer stream as one bitstream through a multiplexer.

As another example, a multiview video may be encoded according to a scalable video coding scheme. Left view images may be encoded as first layer images and right view images may be encoded as second layer images. Alternatively, central view images, left view images, and right view images may be each encoded, wherein the central view images are encoded as first layer images, the left view images are encoded as second layer images, and the right view images are encoded as third layer images. Alternatively, a central view texture image, a central view depth image, a left view texture image, a left view depth image, a right view texture image, and a right view depth image may be respectively encoded as a first layer image, a second layer image, a third layer image, a fourth layer image, a fifth layer image, and a sixth layer image.

As another example, a central view texture image, a central view depth image, a left view depth image, a left view texture image, a right view depth image, and a right view texture image may be respectively encoded as a first layer image, a second layer image, a third layer image, a fourth layer image, a fifth layer image, and a sixth layer image.

As another example, a scalable video coding method may be performed according to temporal hierarchical prediction based on temporal scalability. A first layer stream including encoding information generated by encoding base frame rate images may be output. Temporal levels may be classified according to frame rates and each temporal level may be encoded according to layers. A second layer stream including encoding information of a high frame rate may be output by further encoding higher frame rate images by referring to the base frame rate images.

Also, scalable video coding may be performed on a first layer and a plurality of extension layers (a second layer, a third layer, . . . , a K-th layer). When there are at least three extension layers, first layer images and K-th layer images may be encoded. Accordingly, an encoding result of the first layer images may be output as a first layer stream, and encoding results of the first, second, . . . , K-th layer images may be respectively output as first, second, . . . , K-th layer streams.

The video encoding apparatus 10 according to an embodiment may perform inter prediction in which images of a single layer are referenced in order to predict a current image. By performing inter prediction, a motion vector indicating motion information between a current image and a reference image and a residual component between the current image and the reference image may be predicted from a region corresponding to a first layer (base layer).

Also, when the video encoding apparatus 10 according to an embodiment allows three or more layers, that is, the first layer, the second layer, and the third layer, inter-layer prediction between one first layer image and a third layer image and inter-layer prediction between the second layer image and the third layer image may be performed.

In inter-layer prediction, when a layer of a current image and a layer of a reference image are different from each other in their views, a disparity vector between the current image and the reference image of the layer different from that of the current image may be derived, and a residual component that is a difference component between the current image and a prediction image generated by using the reference image of the different layer may be generated.

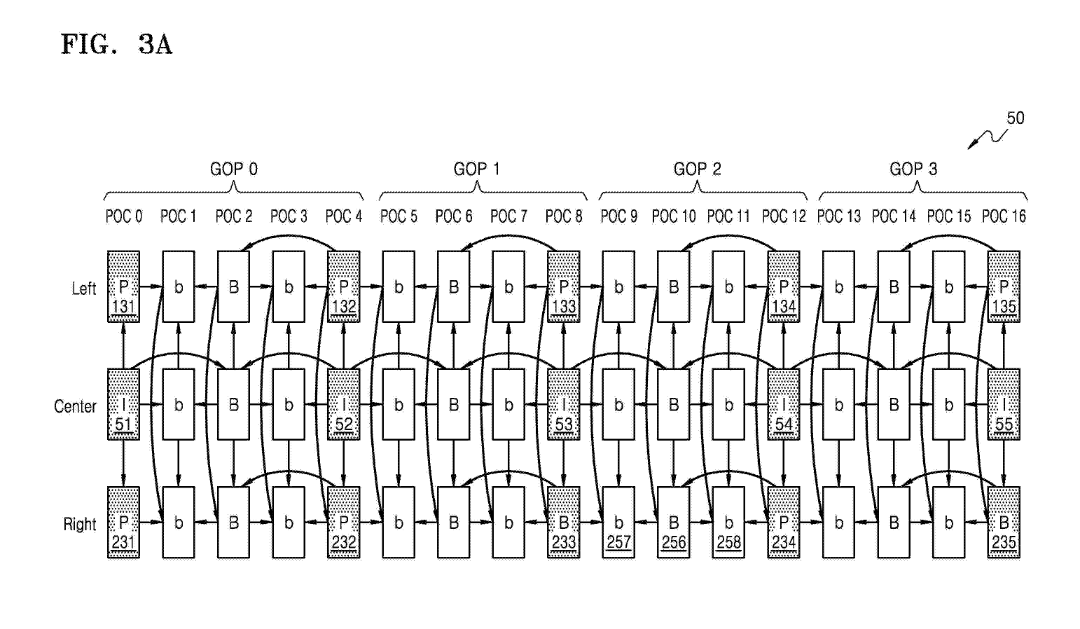

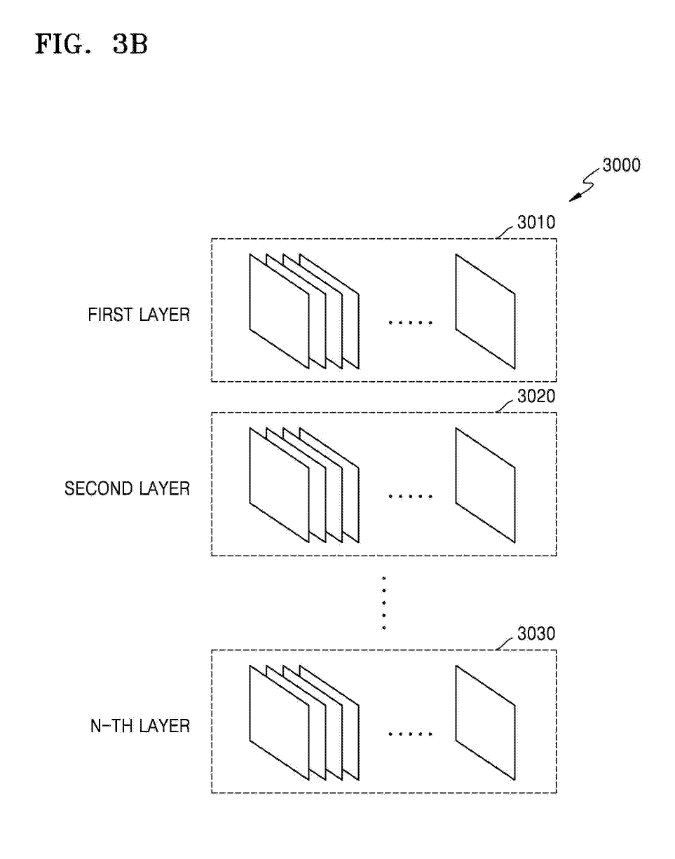

An inter-layer prediction structure will be described later with reference to FIG. 3A.

The video encoding apparatus 10 according to an embodiment may perform encoding according to blocks of each image of a video, according to layers. A block may have a square shape, a rectangular shape, or an arbitrary geometrical shape, and is not limited to a data unit having a predetermined size. The block may be a maximum coding unit, a coding unit, a prediction unit, or a transformation unit, among coding units according to a tree structure. A largest coding unit including coding units of a tree structure may be called differently, such as a coding tree unit, a coding block tree, a block tree, a root block tree, a coding tree, a coding root, or a tree trunk. Video encoding and decoding methods based on coding units according to a tree structure will be described later with reference to FIGS. 8 through 20.

Inter prediction and inter-layer prediction may be performed based on a data unit, such as a coding unit, a prediction unit, or a transformation unit.

The encoder 12 according to an embodiment may generate symbol data by performing source coding operations including inter prediction or intra prediction on first layer images. Symbol data indicates a value of each encoding parameter and a sample value of a residual.

For example, the encoder 12 may generate symbol data by performing inter or intra prediction, transformation, and quantization on samples of a data unit of first layer images, and may generate a first layer stream by performing entropy encoding on the symbol data.

The encoder 12 may encode second layer images based on coding units of a tree structure. The encoder 12 may generate symbol data by performing inter/intra prediction, transformation, and quantization on samples of a coding unit of second layer images, and may generate a second layer stream by performing entropy encoding on the symbol data.

The encoder 12 according to an embodiment may perform inter-layer prediction in which a second layer image is predicted by using prediction information of a first layer image. In order to encode a second layer original image from a second layer image sequence through an inter-layer prediction structure, the encoder 12 may determine prediction information of a second layer current image by using prediction information of a first layer reconstructed image, and may encode a prediction error between the second layer original image and a second layer prediction image by generating the second layer prediction image based on the determined prediction information.

In addition, the encoder 12 may determine a block of the first layer image, which is to be referred by a block of the second layer image, by performing inter-layer prediction on the second layer image according to the coding units or the prediction unit. For example, a reconstructed block of the first layer image may be determined, wherein the reconstructed block corresponds to a location of a current block in the second layer image. The encoder 12 may use the first layer reconstructed block corresponding to the second layer block as a prediction block of the second layer. Here, the encoder 12 may determine a second layer prediction block by using the first layer reconstructed block that is located to correspond to the second layer block.

The encoder 12 may use the second layer prediction block that is determined by using the first layer reconstructed block according to the inter-layer prediction structure, as a reference image for inter-layer prediction of the second layer original block. The encoder 12 may perform entropy encoding of an error between a sample value of the second layer prediction block and a sample value of the second layer original block, e.g., a residual component according to the inter-layer prediction, by using the first layer reconstructed image.

In addition, the video encoding apparatus 10 may encode the current image by using dependency information between layers and/or type information of each layer.

According to various embodiments, the first layer may refer to a second layer. For example, when the encoder 12 encodes the current image included in the first layer, the encoder 12 may use predetermined information regarding encoding of image included in the second layer.

The encoder 12 may generate dependency information indicating reference information between layers.

The encoder 12 may recognize types of images included in each layer. For example, the video encoding apparatus 10 may recognize whether the image included in each layer is a texture image. Also, the video encoding apparatus 10 may recognize whether the image included in each layer is a depth image.

The encoder 12 may generate type information of the image included in each layer. The type information denotes information indicating a type of the image included in each layer. For example, when a value of first layer type information is 1, the image included in the first layer may be a depth image. In addition, when a value of the first layer type information is 0, the image included in the first layer may be a texture image.

The encoder 12 may acquire a reference picture set. The reference picture set is information used in managing a decoded picture buffer (DPB). For example, the encoder 12 may store a picture included in the reference picture set in the DPB as a reference picture, and may remove a picture that is not included in the reference picture set from the DPB in a predetermined time because the picture not included in the reference picture set is a non-reference picture. The reference picture set may include a reference picture of a current picture, a reference picture of a future picture, a picture that is a non-reference picture used for screen output, or a combination thereof.

The encoder 12 may acquire a reference picture set with respect to each of the layers. For example, the encoder 12 may acquire a first reference picture set used to encode the first layer, and a second reference picture set used to encode the second layer.

Also, the encoder 12 may acquire a plurality of reference picture sets with respect to each of the layers. For example, the encoder 12 may acquire a plurality of reference picture sets for the first layer, and may encode the image in the first layer by using the plurality of reference picture sets.

In addition, the encoder 12 may acquire a reference picture set with respect to a plurality of layers. For example, the encoder 12 may acquire a reference picture set used to encode the first layer and the second layer.

The encoder 12 may configure a reference picture list by using some or all of the pictures included in the reference picture set. For example, the video encoding apparatus 10 may include a reference picture for the current picture, from among the pictures included in the reference picture set, in the reference picture list.

The encoder 12 may acquire a reference picture list with respect to each of the layers. For example, the encoder 12 may acquire a first reference picture list used to encode the first layer, and a second reference picture list used to encode the second layer.

Also, the encoder 12 may acquire a plurality of reference picture lists with respect to each of the layers. For example, the encoder 12 may acquire a plurality of reference picture lists with respect to the first layer, and may encode the image of the first layer by using the plurality of reference picture sets.

In addition, the encoder 12 may acquire a reference picture list with respect to a plurality of layers. For example, the encoder 12 may acquire a reference picture set used to encode the first layer and the second layer.

The encoder 12 may acquire a reference picture set of the first layer based on whether the type information of the first layer and the type information of the second layer are equal to each other, when the first layer refers to the second layer.

For example, when a value of the dependency information indicating whether the first layer refers to the second layer and a value of the type information of the first layer and a value of the type information of the second layer are both 1, the encoder 12 may include pictures of the second layer in a reference picture set of the first layer.

Also, when the value of the dependency information indicating whether the first layer refers to the second layer is 1 and the value of the type information of the first layer and the value of the type information of the second layer are both 0, the video encoding apparatus 10 may include pictures of the second layer in the reference picture set of the first layer.

When the first layer refers to the second layer, the encoder 12 may acquire the reference picture set of the first layer based on whether the type of the first layer is equal to the type of the second layer.

For example, when the value of dependency information indicating whether the first layer refers to the second layer is 1 and the type of the first layer is equal to the type of the second layer, e.g., texture image, the encoder 12 may include pictures of the second layer in the reference picture set of the first layer.

Also, when the value of the dependency information indicating whether the first layer refers to the second layer is 1 and the type of the first layer is equal to the type of the second layer, e.g., depth image, the encoder 12 may include pictures of the second layer in the reference picture set of the first layer.

When the first layer refers to the second layer and the type information of the first layer and the type information of the second layer are different from each other, the encoder 12 may not include the pictures of the second layer in the reference picture set of the first layer. In this case, the encoder 12 may use predetermined information regarding decoding of the image included in the second layer when the current image in the first layer is decoded.

For example, the encoder 12 may use a motion vector of the image included in the second layer when the current image included in the first layer is decoded.

The encoder 12 may configure a reference picture list of the current image included in the first layer, by using some or all of the pictures included in the reference picture set of the first layer. For example, the encoder 12 may configure the reference picture list of the current image in the first layer, by including some of the pictures of the reference picture set of the first layer.

According to another embodiment, when the first layer refers to the second layer, the encoder 12 may generate a reference picture list of the first layer based on whether the type information of the first layer and the type information of the second layer are equal to each other, when the first layer refers to the second layer.

For example, when a value of the dependency information indicating whether the first layer refers to the second layer is 1 and a value of the type information of the first layer and a value of the type information of the second layer are both 1, the encoder 12 may include the pictures of the second layer in the reference picture list of the first layer.

In addition, when a value of the dependency information indicating whether the first layer refers to the second layer is 1 and the value of the type information of the first layer and the value of the type information of the second layer are both 0, the video encoding apparatus 10 may include the pictures of the second layer in the reference picture list of the first layer.

According to another embodiment, the encoder 12 may acquire the reference picture list of the first layer based on whether the type of the first layer is equal to the type of the second layer, when the first layer refers to the second layer.

For example, when the value of the dependency information indicating whether the first layer refers to the second layer is 1 and the type of the first layer and the type of the second layer are equal to each other, e.g., texture images, the encoder 12 may include the pictures of the second layer in the reference picture list of the first layer.

Also, when the value of the dependency information indicating whether the first layer refers to the second layer is 1 and the type of the first layer and the type of the second layer are equal to each other, e.g., the depth image, the encoder 12 may include the pictures of the second layer in the reference picture list of the first layer.

The bitstream generator 14 generates a bitstream including inter-layer prediction information determined in relation to the encoded video and the inter-layer prediction, and transmits the generated bitstream to a decoding apparatus. Also, the bitstream generator 14 may include generated dependency information and/or type information of each layer in the bitstream.

Hereinafter, operations of the video encoding apparatus 10 for inter-layer prediction will be described below with reference to FIG. 1B.

FIG. 1B is a flowchart of a multi-layer video encoding method according to an embodiment.

In operation S11, the video encoding apparatus 10 may generate dependency information indicating whether the first layer refers to the second layer.

According to various embodiments, the first layer may refer to the second layer. For example, the video encoding apparatus 10 may use predetermined information regarding encoding of the image included in the second layer when a current image included in the first layer is encoded.

Also, the video encoding apparatus 10 may use motion information of the image included in the second layer to encode the current image included in the first layer.

The video encoding apparatus 10 may determine motion information of a current block included in the first layer based on motion information of a block included in the second layer, and may determine a block indicated by the determined motion information as a prediction block of the current block. In addition, the video encoding apparatus 10 may encode the current block by using the determined prediction block.

In addition, the video encoding apparatus 10 may include pictures of the second layer in the reference picture set of the current image, when the current image in the first layer is encoded.

The video encoding apparatus 10 may configure the reference picture list of the current image by including some or all of the pictures of the reference picture set of the current image, and may perform an inter prediction or inter-layer prediction by using the pictures included in the reference picture list of the current image in order to encode the current image.

The video encoding apparatus 10 may generate dependency information indicating the reference between the layers.

For example, when the first layer refers to the second layer, the video encoding apparatus 10 may generate dependency information having a value of 1. In addition, if the first layer does not refer to the second layer, the video encoding apparatus 10 may generate dependency information having a value of 0.

The video encoding apparatus 10 may generate a plurality of pieces of dependency information. For example, the video encoding apparatus 10 may generate dependency information indicating whether the first layer refers to the second layer, and dependency information indicating whether the first layer refers to the third layer.

The above dependency information is an example, that is, the video encoding apparatus 10 may generate various types of dependency information indicating references between some of the plurality of layers. In addition, the video encoding apparatus 10 may include the generated dependency information in the bitstream.

In operation S13, if the dependency information indicates that the first layer refers to the second layer, the video encoding apparatus 10 may acquire a reference picture set of the first layer based on whether type information of the first layer and type information of the second layer are equal to each other.

The video encoding apparatus 10 may recognize a type of an image included in each layer. For example, the video encoding apparatus 10 may recognize whether the image included in the first layer is a texture image. In addition, the video encoding apparatus 10 may recognize whether the image included in the first layer is a depth image.

The video encoding apparatus 10 may generate type information of the image included in each layer. The type information indicates types of images included in each layer.

The type information may indicate whether the images included in each layer are the depth images. In addition, the type information may indicate whether the images included in each layer are texture images.

For example, if a value of the type information of the first layer is 1, the image included in the first layer may be a depth image. In addition, if the value of the type information of the first layer is 0, the image included in the first layer may be a texture image.

The video encoding apparatus 10 may obtain a reference picture set. The reference picture set is information used to manage the DPB. For example, the video encoding apparatus 10 may store the pictures included in the reference picture set in the DPB as reference pictures, and may remove the pictures that are not included in the reference picture set from the DPB in a predetermined time because the pictures not included in the reference picture set are non-reference pictures. The reference picture set may include may include reference pictures with respect to the current picture, reference pictures with respect to a future picture, pictures that are non-reference pictures for screen output, or combinations thereof.

The video encoding apparatus 10 may obtain a reference picture set with respect to each of layers. For example, the video encoding apparatus 10 may obtain a first reference picture set used to encode the first layer, and may obtain a second reference picture set used to encode the second layer.

Also, the video encoding apparatus 10 may obtain a plurality of reference picture sets with respect to each of the layers. For example, the video encoding apparatus 10 may obtain a plurality of reference picture sets with respect to the first layer, and may encode the image of the first layer by using the plurality of reference picture sets.

Also, the video encoding apparatus 10 may obtain a reference picture set with respect to a plurality of layers. For example, the video encoding apparatus 10 may obtain the reference picture set used to encode the first layer and the second layer.

The video encoding apparatus 10 may configure a reference picture list by using some or all of the pictures included in the reference picture set. For example, the video encoding apparatus 10 may include the reference picture of the current picture, from among the pictures included in the reference picture set, in the reference picture list.

The video encoding apparatus 10 may obtain the reference picture list with respect to each of the layers. For example, the video encoding apparatus 10 may obtain a first reference picture list used to encode the first layer, and a second reference picture list used to encode the second layer.

Also, the video encoding apparatus 10 may obtain a plurality of reference picture lists with respect to each of the layers. For example, the video encoding apparatus 10 may obtain a plurality of reference picture lists with respect to the first layer, and may encode the image of the first layer by using the plurality of reference picture lists.

In addition, the video encoding apparatus 10 may obtain a reference picture lists with respect to the plurality of layers. For example, the video encoding apparatus 10 may obtain the reference picture list used to encode the first layer and the second layer.

If the first layer refers to the second layer, the video encoding apparatus 10 may obtain the reference picture set of the first layer based on whether the type information of the first layer and the type information of the second layer are equal to each other.

For example, in a case where a value of dependency information indicating whether the first layer refers to the second layer is 1 and a value of the type information of the first layer and a value of the type information of the second layer are both 1, the video encoding apparatus 10 may include the pictures of the second layer in the reference picture set of the first layer.

Also, in a case where the value of the dependency information indicating whether the first layer refers to the second layer is 1 and the type information value of the first layer and the type information value of the second layer are both 0, the video encoding apparatus 10 may include the pictures of the second layer in the reference picture set of the first layer.

When the first layer refers to the second layer, the video encoding apparatus 10 may obtain the reference picture set of the first layer based on whether the type of the first layer and the type of the second layer are equal to each other.

For example, if the value of dependency information indicating whether the first layer refers to the second layer is 1 and the type of the first layer and the type of the second layer are equal to each other, e.g., texture images, the video encoding apparatus 10 may include the pictures of the second layer in the reference picture set of the first layer.

Also, when the value of the dependency information indicating whether the first layer refers to the second layer is 1 and the type of the first layer and the type of the second layer are equal to each other, e.g., the depth image, the video encoding apparatus 10 may include the pictures of the second layer in the reference picture set of the first layer.

When the first layer refers to the second layer and the type information of the first layer and the type information of the second layer are different from each other, the video encoding apparatus 10 may not include the pictures of the second layer in the reference picture set and the reference picture list of the first layer.

For example, when the value of dependency information indicating whether the first layer refers to the second layer is 1, the type information value of the first layer is 1, and the type information value of the second layer is 0, the video encoding apparatus 10 may not include the pictures of the second layer in the reference picture set and the reference picture list of the first layer.

Also, in a case where the value of the dependency information indicating whether the first layer refers to the second layer is 1, the type information value of the first layer is 0, and the type information value of the second layer is 1, the video encoding apparatus 10 may not include the pictures of the second layer in the reference picture set and the reference picture list of the first layer.

When the first layer refers to the second layer and the type information of the first layer and the type information of the second layer are different from each other, the video encoding apparatus 10 may use predetermined information regarding the encoding of the image included in the second layer when the current image included in the first layer is encoded.

For example, the video encoding apparatus 10 may use a motion vector of the image included in the second layer when encoding the current image included in the first layer. The video encoding apparatus 10 may determine a motion vector of the current block included in the first layer based on the motion vector of the block included in the second layer, and may determine a block indicated by the motion vector as a prediction block of the current block. In addition, the video encoding apparatus 10 may encode the current image by using the prediction block.

When the first layer refers to the second layer and the first layer and the second layer have different types, the video encoding apparatus 10 may not include the pictures of the second layer in the reference picture set and the reference picture list of the first layer.

For example, in a case where the value of dependency information indicating whether the first layer refers to the second layer is 1, the type of the first layer is the texture image, and the type of the second layer is the depth image, the pictures included in the second layer may not be included in the reference picture set and the reference picture list of the first layer.

In addition, in a case where the value of dependency information indicating whether the first layer refers to the second layer is 1, the type of the first layer is the depth image, and the type of the second layer is the texture image, the pictures included in the second layer may not be included in the reference picture set and the reference picture list of the first layer.

If the first layer refers to the second layer and the type of the first layer is different from the type of the second layer, the video encoding apparatus 10 may use predetermined information regarding the encoding of the image included in the second layer when encoding the current image in the first layer.

For example, when the current image included in the first layer is encoded, the video encoding apparatus 10 may use the motion vector of the image included in the second layer. The video encoding apparatus 10 determines the motion vector of the current block included in the first layer based on the motion vector of the block included in the second layer, and may determine a block indicated by the motion vector as a prediction block of the current block. In addition, the video encoding apparatus 10 may encode the current block by using the prediction block.

When the value of the dependency information indicating whether the first layer refers to the second layer, the pictures in the second layer may not be included in the reference picture set of the first layer.

In operation S15, the video encoding apparatus 10 may encode the current image included in the first layer based on the reference picture set of the first layer.

The video encoding apparatus 10 may configure the reference picture list of the current image included in the first layer by using some or all of the pictures included in the reference picture set of the first layer. For example, the video encoding apparatus 10 may configure the reference picture list of the current image in the first layer, by using some of the pictures included in the reference picture set of the first layer.

According to another embodiment, the video encoding apparatus 10 may obtain the reference picture list of the first layer based on whether the type information of the first layer is equal to the type information of the second layer when the first layer refers to the second layer.

For example, when the value of the dependency information indicating whether the first layer refers to the second layer is 1 and the type information value of the first layer and the type information value of the second layer are 1, the pictures included in the second layer may be included in the reference picture list of the first layer.

In addition, when the value of the dependency information indicating whether the first layer refers to the second layer is 1 and the type information value of the first layer and the type information value of the second layer are both 0, the pictures in the second layer may be included in the reference picture list of the first layer.

According to another embodiment, the video encoding apparatus 10 may obtain the reference picture list of the first layer based on whether the type of the first layer is equal to the type of the second layer when the first layer refers to the second layer.

For example, when the value of the dependency information indicating whether the first layer refers to the second layer is 1 and the type of the first layer and the type of the second layer are the texture images, the pictures included in the second layer may be included in the reference picture list of the first layer.

Also, when the value of the dependency information indicating whether the first layer refers to the second layer is 1 and the type of the first layer and the type of the second layer are the same as each other, that is, the depth images, the pictures included in the second layer may be included in the reference picture list of the first layer.

The video encoding apparatus 10 may encode the current image included in the first layer by using the pictures included in the reference picture list of the first layer. For example, the video encoding apparatus 10 may encode the current image by detecting a picture corresponding to the current image, from among the pictures included in the reference picture list of the first layer, and by performing motion compensation, inter-layer prediction, or disparity compensation on the detected picture. However, the embodiments are not limited thereto, that is, the video encoding apparatus 10 may encode the current image included in the first layer by using the pictures included in the reference picture list of the first layer in various ways.

The multi-layer video encoding apparatus 10 according to the embodiment may include a central processor (not shown) that controls both the encoder 12 and the bitstream generator 14. Alternatively, the encoder 12 and the bitstream generator 14 are driven by their own processors (not shown), and the processors (not shown) may operate in association with each other to generally control the multi-layer video encoding apparatus 10. Alternatively, the encoder 12 and the bitstream generator 14 may be controlled by an external processor (not shown) of the multi-layer video encoding apparatus 10.

The multi-layer video encoding apparatus 10 may include one or more data storages (not shown) in which input/output data of the encoder 12 and the bitstream generator 14 is stored. The multi-layer video encoding apparatus 10 may include a memory controller (not shown) that controls data input/output to/from the data storages (not shown).

The multi-layer video encoding apparatus 10 operates in association with a video encoding processor mounted therein or an external video encoding processor in order to output a result of encoding video, and then, the video encoding operation including transformation may be performed. The internal video encoding processor of the multi-layer video encoding apparatus 10 may implement the video encoding operations as a separate processor. In addition, the multi-layer video encoding apparatus 10 or a central operator and a graphic operator include the video encoding processing module so as to implement basic video encoding operations.

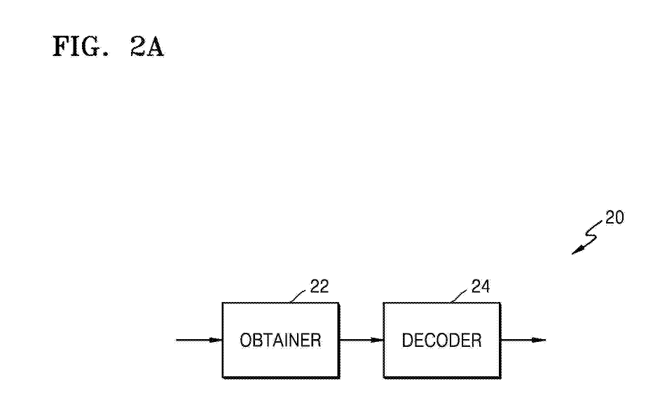

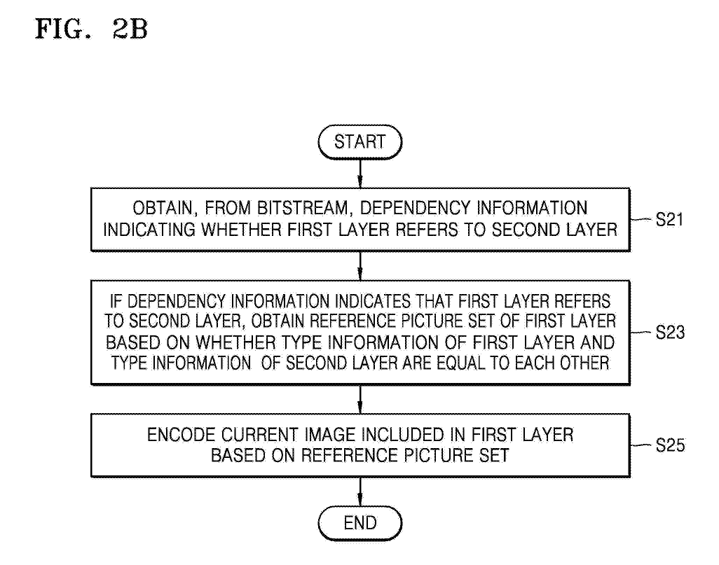

FIG. 2A is a block diagram of a multi-layer decoding apparatus 20 according to an embodiment.

Referring to FIG. 2A, the multi-layer decoding apparatus 20 may include an obtainer 22 and a decoder 24.

In the inter-layer video decoding apparatus 20 according to an embodiment, symbols may be parsed from a bitstream according to layers.

The multi-layer video decoding apparatus 20 based on spatial scalability may receive a stream in which image sequences having different resolutions are encoded in different layers. A first layer stream may be decoded to reconstruct an image sequence having low resolution and a second layer stream may be decoded to reconstruct an image sequence having high resolution.

As another example, a multiview video may be decoded according to a scalable video coding scheme. When a stereoscopic video stream is decoded in a plurality of layers, a first layer stream may be decoded to reconstruct left view images. A second layer stream may be further decoded to reconstruct right view images.

Alternatively, when a multiview video stream is decoded in a plurality of layers, a first layer stream may be decoded to reconstruct central view images. A second layer stream may be further decoded to reconstruct left view images. A third layer stream may be further decoded to reconstruct right view images.

As another example, a scalable video coding method based on temporal scalability may be performed. A first layer stream may be decoded to reconstruct base frame rate images. A second layer stream may be further decoded to reconstruct high frame rate images.

Also, when there are at least three second layers, first layer images may be reconstructed from a first layer stream, and when a second layer stream is further decoded by referring to first layer reconstruction images, second layer images may be further reconstructed. When K-th layer stream is further decoded by referring to second layer reconstruction images, K-th layer images may be further reconstructed.

The multi-layer video decoding apparatus 20 may obtain encoded data of first layer images and second layer images from a first layer stream and a second layer stream, and in addition, may further obtain a motion vector generated via inter prediction and prediction information generated via inter-layer prediction.

For example, the multi-layer video decoding apparatus 20 may decode inter-predicted data per layer, and may decode inter-layer predicted data between a plurality of layers. Reconstruction may be performed through motion compensation and inter-layer video decoding based on a coding unit or a prediction unit.

Images may be reconstructed by performing motion compensation for a current image by referring reconstruction images predicted via inter prediction of a same layer, with respect to each layer stream. Motion compensation is an operation in which a reconstruction image of a current image is reconstructed by synthesizing a reference image determined by using a motion vector of the current image and a residual component of the current image.

Also, the multi-layer video decoding apparatus 20 may perform inter-layer video decoding by referring to prediction information of first layer images so as to decode a second layer image predicted via inter-layer prediction. Inter-layer video decoding is an operation in which prediction information of a current image is reconstructed by using prediction information of a reference block of a different layer so as to determine the motion information of the current image.

The multi-layer video decoding apparatus 20 according to an embodiment may perform inter-layer video decoding for reconstructing third layer images predicted by using second layer images. An inter-layer prediction structure will be described later with reference to FIG. 3A.

However, the decoder 24 according to an embodiment may decode a second layer stream without having to refer to a first layer image sequence. Accordingly, it should not be limitedly construed that the decoder 24 performs inter-layer prediction to decode a second layer image sequence.

The multi-layer video decoding apparatus 20 performs decoding according to blocks of each image of a video. A block may be, from among coding units according to a tree structure, a largest coding unit, a coding unit, a prediction unit, or a transformation unit.

The obtainer 22 may receive a bitstream and may obtain, from the received bitstream, information about an encoded video.

The decoder 24 may decode a first layer image by using symbols of the first layer image parsed from the bitstream. When the multi-layer video decoding apparatus 20 receives streams encoded based on coding units of a tree structure, the decoder 24 may perform decoding based on the coding units of the tree structure, according to a largest coding unit of a first layer stream.

The decoder 24 may obtain encoding information and encoded data by performing entropy decoding per largest coding unit. The decoder 24 may reconstruct a residual component by performing inverse quantization and inverse transformation on encoded data obtained from a stream. The decoder 24 according to another embodiment may directly receive a bitstream of quantized transformation coefficients. Residual components of images may be reconstructed by performing inverse quantization and inverse transformation on quantized transformation coefficients.

The decoder 24 may determine a prediction image via motion compensation between same layer images, and reconstruct first layer images by combining the prediction image and a residual.

According to an inter-layer prediction structure, the decoder 24 may generate a second layer prediction image by using samples of a first layer reconstruction image. The decoder 24 may obtain a prediction error according to inter-layer prediction by decoding a second layer stream. The decoder 24 may generate a second layer reconstruction image by combining a second layer prediction image and the prediction error.

The decoder 24 may determine a second layer prediction image by using a first layer reconstruction image decoded by the decoder 24. According to an inter-layer prediction structure, the decoder 24 may determine a block of a first layer image, which is to be referred by a coding unit or a prediction unit, of a second layer image. For example, a reconstruction block of a first layer image, which is located correspondingly to a location of a current block in a second layer image, may be determined. The decoder 24 may determine a second layer prediction block by using a first layer reconstruction block corresponding to a second layer block. The decoder 24 may determine the second layer prediction block by using the first layer reconstruction block co-located with the second layer block.

The decoder 24 may use a second layer prediction block that is determined by using a first layer reconstruction block according to an inter-layer prediction structure, as a reference image for inter-layer prediction of a second layer original block. In this case, the decoder 24 may reconstruct a second layer block by synthesizing a sample value of a second layer prediction block determined by using a first layer reconstruction image and a residual component according to inter-layer prediction.

In addition, the video decoding apparatus 20 may decode the current image by using dependency information between layers and/or type information of each layer.

The obtainer 22 may obtain dependency information between the layers. The dependency information is information indicating references between the layers.

For example, when a value of dependency information indicating whether the first layer refers to the second layer, the first layer may be decoded by referring to the second layer.

Also, when a value of the dependency information indicating whether the first layer refers to the second layer, the first layer may be decoded without referring to the second layer.

According to another embodiment, if the first layer refers to the second layer, the decoder 24 may use predetermined information regarding the decoding of the image included in the second layer when decoding the current image included in the first layer.

The decoder 24 may obtain type information of the image included in each layer. The type information denotes information indicating type of the images included in each layer. For example, when a value of the type information of the first layer is 1, the image included in the first layer may be a depth image. In addition, when the value of the type information of the first layer is 0, the image included in the first layer may be a texture image.

The decoder 24 may obtain a reference picture set. The reference picture set is information used to manage a DPB. For example, the decoder 24 may store a picture included in the reference picture set in the DPB as a reference picture, and may remove a picture that is not included in the reference picture set, that is, a non-reference picture, from the DPB in a predetermined time. The reference picture set may include a reference picture of a current picture, a reference picture of a future picture, a picture for screen output, that is, a non-reference picture, or a combination thereof.

The decoder 24 may obtain a reference picture set with respect to each of the layers. For example, the decoder 24 may obtain a first reference picture set used to decode the first layer, and a second reference picture set used to decode the second layer.

The decoder 24 may obtain a plurality of reference picture sets with respect to each of the layers. For example, the decoder 24 may obtain a plurality of reference picture sets with respect to the first layer, and may decode the image of the first layer by using the plurality of reference picture sets.

In addition, the decoder 24 may obtain a reference picture set with respect to a plurality of layers. For example, the decoder 24 may obtain a reference picture set used to decode the first layer and the second layer.

The decoder 24 may configure a reference picture list by using some or all of the pictures included in the reference picture set. For example, from among the pictures included in the reference picture set, a reference picture of the current picture may be included in the reference picture list.

The decoder 24 may obtain a reference picture list with respect to each of the layers. For example, the decoder 24 may obtain a first reference picture list used to decode the first layer, and a second reference picture list used to decode the second layer.

Also, the decoder 24 may obtain a plurality of reference picture lists with respect to each of the layers. For example, the decoder 24 may obtain a plurality of reference picture lists with respect to the first layer, and may decode the image of the first layer by using the plurality of reference picture lists.

Also, the decoder 24 may obtain a reference picture list with respect to the plurality of layers. For example, the decoder 24 may obtain a reference picture list used to decode the first layer and the second layer.

The decoder 24 may obtain a reference picture set of the first layer based on whether the type information of the first layer and the type information of the second layer are the same as each other when the first layer refers to the second layer.

For example, when a value of the dependency information indicating whether the first layer refers to the second layer is 1 and the type information value of the first layer and the type information value of the second layer are both 1, the pictures included in the second layer may be included in a reference picture set of the first layer.

Also, when the value of the dependency information indicating whether the first layer refers to the second layer is 1 and the type information value of the first layer and the type information value of the second layer are both 0, the pictures included in the second layer may be included in the reference picture set of the first layer.

The decoder 24 may obtain the reference picture set of the first layer based on whether the type of the first layer and the type of the second layer are the same as each other when the first layer refers to the second layer.

For example, when the value of the dependency information indicating whether the first layer refers to the second layer is 1 and the type of the first layer and the type of the second layer are the same as each other, e.g., the texture image, the pictures included in the second layer may be included in the reference picture set of the first layer.

Also, when the value of the dependency information indicating whether the first layer refers to the second layer is 1 and the type of the first layer and the type of the second layer are the same as each other, e.g., depth image, the pictures included in the second layer may be included in the reference picture set of the first layer.

When the first layer refers to the second layer and the type information of the first layer is different from the type information of the second layer, the pictures of the second layer may not be included in the reference picture set of the first layer. In this case, the decoder 24 may use predetermined information regarding the decoding of the image included in the second layer when decoding the current image of the first layer.

For example, the decoder 24 may use a motion vector of the image included in the second layer when decoding the current image of the first layer.

The decoder 24 may configure a reference picture list of the current image included in the first layer by using some or all of the pictures included in the reference picture set of the first layer. For example, the decoder 24 may configure the reference picture list of the current image included in the first layer by using some of the pictures included in the reference picture set of the first layer.

According to another embodiment, the decoder 24 may generate the reference picture list of the first layer based on whether the type information of the first layer is the same as the type information of the second layer when the first layer refers to the second layer.

For example, when a value of the dependency information indicating whether the first layer refers to the second layer is 1 and the type information value of the first layer and the type information value of the second layer are both 1, the pictures included in the second layer may be included in the reference picture list of the first layer.

In addition, when the value of the dependency information indicating whether the first layer refers to the second layer is 1 and the type information value of the first layer and the type information value of the second layer are both 0, the pictures included in the second layer may be included in the reference picture list of the first layer.

According to another embodiment, when the decoder 24 may obtain a reference picture list of the first layer based on whether the type of the first layer is the same as the type of the second layer when the first layer refers to the second layer.

For example, when the value of the dependency information indicating whether the first layer refers to the second layer is 1 and the type of the first layer and the type of the second layer are the texture images, the pictures included in the second layer may be included in the reference picture list of the first layer.

In addition, when the value of the dependency information indicating whether the first layer refers to the second layer is 1 and the type of the first layer and the type of the second layer are the same as each other, e.g., depth image, the pictures included in the second layer may be included in the reference picture list of the first layer.

The decoder 24 may reconstruct the current image included in the first layer by using the pictures included in the reference picture list of the first layer. For example, the decoder 24 may reconstruct the current image by detecting a picture corresponding to the current image, from among the pictures included in the reference picture list of the first layer, and performing motion compensation, inter-layer prediction, or disparity compensation. The decoder 24 may reconstruct the current image included in the first layer by using the pictures included in the reference picture list of the first layer in various ways.

Hereinafter, operations of the multi-layer video decoding apparatus 10 for inter-layer prediction will be described below with reference to FIG. 2B.

FIG. 2B is a flowchart of a multi-layer video decoding method according to an embodiment.

In operation S21, the video encoding apparatus 20 may obtain dependency information indicating whether the first layer refers to the second layer from a bitstream.

According to various embodiments, the video decoding apparatus 20 may refer to the second layer when decoding the current image included in the first layer.

For example, the video decoding apparatus 20 may use predetermined information regarding the decoding of the image included in the second layer, when decoding the current image included in the first layer. Also, the video decoding apparatus 20 may use motion information of the image included in the second layer when decoding the current image included in the first layer.

The video decoding apparatus 20 may determine motion information of a block included in the second layer based on the motion information of the block included in the first layer, and may determine a block indicated by the motion information as a prediction block of the current block. In addition, the video decoding apparatus 20 may decode the current block by using the prediction block.

In addition, for example, the pictures included in the second layer may be included in the reference picture set of the current image when the video decoding apparatus 20 decodes the current image included in the first layer.

The video decoding apparatus 20 configures a reference picture list of the current image by using some or all of the pictures included in the reference picture set of the current image, and performs an inter prediction or an inter-layer prediction by using the pictures included in the reference picture list of the current image so as to decode the current image.

The video decoding apparatus 20 may obtain dependency information from a bitstream. The dependency information may indicate references between the layers.

For example, when a value of the dependency information indicating whether the first layer refers to the second layer is 1, the first layer may be decoded by referring to the second layer. In addition, when the value of the dependency information indicating whether the first layer refers to the second layer is 0, the first layer may be decoded without referring to the second layer.

The video decoding apparatus 20 may obtain a plurality pieces of dependency information. For example, the video decoding apparatus 20 may obtain dependency information indicating whether the first layer refers to the second layer, and dependency information indicating whether the first layer refers to a third layer.

The above-described dependency information is an example, and the video decoding apparatus 20 is not limited thereto, that is, may obtain dependency information of various types indicating whether to refer to some of the plurality of layers.

In operation S23, when the dependency information indicates that the first layer refers to the second layer, the video decoding apparatus 20 may obtain a reference picture set of the first layer based on whether the type information of the first layer is the same as the type information of the second layer.

The video decoding apparatus 20 may obtain the type information of the first layer and the type information of the second layer. The type information may indicate whether the images included in each layer are the depth images. In addition, the type information may indicate whether the images included in each layer are the texture images.

For example, when the type information value of the first layer is 1, the image included in the first layer may be a depth image. In addition, when the type information value of the first layer is 0, the image included in the first layer may be a texture image.

The video decoding apparatus 20 may obtain a reference picture set. The reference picture set is information used to manage a DPB. For example, the video decoding apparatus 20 may store a picture included in the reference picture set in the DPB as a reference picture, and may remove a picture that is not included in the reference picture set, that is, a non-reference picture, from the DPB in a predetermined time. The reference picture set may include a reference picture of a current picture, a reference picture of a future picture, a picture for screen output, that is, a non-reference picture, or a combination thereof.

The video decoding apparatus 20 may obtain a reference picture set with respect to each of the layers. For example, the video decoding apparatus 20 may obtain a first reference picture set used to decode the first layer, and a second reference picture set used to decode the second layer.

The video decoding apparatus 20 may obtain a plurality of reference picture sets with respect to each of the layers. For example, the video decoding apparatus 20 may obtain a plurality of reference picture sets with respect to the first layer, and may decode the image of the first layer by using the plurality of reference picture sets.

In addition, the video decoding apparatus 20 may obtain a reference picture set with respect to a plurality of layers. For example, the video decoding apparatus 20 may obtain a reference picture set used to decode the first layer and the second layer.

The video decoding apparatus 20 may configure a reference picture list by using some or all of the pictures included in the reference picture set. For example, from among the pictures included in the reference picture set, a reference picture of the current picture may be included in the reference picture list.

The video decoding apparatus 20 may obtain a reference picture list with respect to each of the layers. For example, the video decoding apparatus 20 may obtain a first reference picture list used to decode the first layer, and a second reference picture list used to decode the second layer.

Also, the video decoding apparatus 20 may obtain a plurality of reference picture lists with respect to each of the layers. For example, the video decoding apparatus 20 may obtain a plurality of reference picture lists with respect to the first layer, and may decode the image of the first layer by using the plurality of reference picture lists.

Also, the video decoding apparatus 20 may obtain a reference picture list with respect to the plurality of layers. For example, the video decoding apparatus 20 may obtain a reference picture list used to decode the first layer and the second layer.

The video decoding apparatus 20 may obtain a reference picture set of the first layer based on whether the type information of the first layer and the type information of the second layer are the same as each other when the first layer refers to the second layer.

For example, when a value of the dependency information indicating whether the first layer refers to the second layer is 1 and the type information value of the first layer and the type information value of the second layer are both 1, the pictures included in the second layer may be included in a reference picture set of the first layer.

Also, when the value of the dependency information indicating whether the first layer refers to the second layer is 1 and the type information value of the first layer and the type information value of the second layer are both 0, the pictures included in the second layer may be included in the reference picture set of the first layer.

The video decoding apparatus 20 may obtain the reference picture set of the first layer based on whether the type of the first layer and the type of the second layer are the same as each other when the first layer refers to the second layer.

For example, when the value of the dependency information indicating whether the first layer refers to the second layer is 1 and the type of the first layer and the type of the second layer are the same as each other, e.g., the texture image, the pictures included in the second layer may be included in the reference picture set of the first layer.

Also, when the value of the dependency information indicating whether the first layer refers to the second layer is 1 and the type of the first layer and the type of the second layer are the same as each other, e.g., depth image, the pictures included in the second layer may be included in the reference picture set of the first layer.

When the first layer refers to the second layer and the type information of the first layer is different from the type information of the second layer, the pictures of the second layer may not be included in the reference picture set of the first layer.

For example, when the value of the dependency information indicating whether the first layer refers to the second layer is 1, the type information value of the first layer is 1, and the type information value of the second layer is 0, the pictures included in the second layer may not be included in the reference picture set and the reference picture list of the first layer.

In addition, when the value of the dependency information indicating whether the first layer refers to the second layer is 1, the type information value of the first layer is 0, and the type information value of the second layer is 1, the pictures included in the second layer may not be included in the reference picture set and the reference picture list of the first layer.

When the first layer refers to the second layer and the type information of the first layer is different from the type information of the second layer, the video decoding apparatus 20 may use predetermined information regarding the decoding of the image included in the second layer when decoding the current image included in the first layer.

For example, the video decoding apparatus 20 may use a motion vector of the image included in the second layer when decoding the current image of the first layer. The video decoding apparatus 20 may determine a motion vector of the current block included in the first layer based on the motion vector of a block included in the second layer and may determine a block indicated by the determined motion vector as a prediction block of the current block. Also, the video decoding apparatus 20 may decode the current block by using the prediction block.

When the first layer refers to the second layer and the types of the first layer and the second layer are different from each other, the pictures included in the second layer may not be included in the reference picture set and the reference picture list of the first layer.

For example, when the value of the dependency information indicating whether the first layer refers to the second layer is 1, the type of the first layer is the texture image, and the type of the second layer is the depth image, the pictures included in the second layer may not be included in the reference picture set and the reference picture list of the first layer.

In addition, when the value of the dependency information indicating whether the first layer refers to the second layer is 1, the type of the first layer is the depth image, and the type of the second layer is the texture image, the pictures included in the second layer may not be included in the reference picture set and the reference picture list of the first layer.

When the first layer refers to the second layer and the types of the first and second layers are different from each other, the video decoding apparatus 20 may use predetermined information regarding the decoding of the image included in the second layer when decoding the current image included in the first layer.

For example, the video decoding apparatus 20 may use a motion vector of the image included in the second layer when decoding the current image included in the first layer. The video decoding apparatus 20 may determine a motion vector of the current block included in the first layer based on a motion vector of the block included in the second layer, and may determine a block indicated by the determined motion vector as a prediction block of the current block. Also, the video decoding apparatus 20 may decode the current block by using the prediction block.

When the value of the dependency information indicating whether the first layer refers to the second layer is 0, the pictures included in the second layer may not be included in the reference picture set of the first layer.

In operation S25, the video decoding apparatus 20 may decode encoded data of the current image included in the first layer, based on the reference picture set of the first layer.

The video decoding apparatus 20 may configure a reference picture list of the current image included in the first layer by using some or all of the pictures included in the reference picture set of the first layer. For example, the video decoding apparatus 20 may configure the reference picture list of the current image included in the first layer by using some of the pictures included in the reference picture set of the first layer.

According to another embodiment, the video decoding apparatus 20 may obtain the reference picture list of the first layer based on whether the type information of the first layer is equal to the type information of the second layer, when the first layer refers to the second layer.

For example, when the value of the dependency information indicating whether the first layer refers to the second layer is 1 and the type information value of the first layer and the type information value of the second layer are both 1, the pictures included in the second layer may be included in the reference picture list of the first layer.

Also, when the value of the dependency information indicating whether the first layer refers to the second layer is 1 and the type information value of the first layer and the type information value of the second layer are both 0, the pictures included in the second layer may be included in the reference picture list of the first layer.

According to another embodiment, the video decoding apparatus 20 may obtain the reference picture list of the first layer based on whether the type of the first layer is the same as the type of the second layer, when the first layer refers to the second layer.

For example, when the value of the dependency information indicating whether the first layer refers to the second layer is 1 and the type of the first layer and the type of the second layer are both the texture images, the pictures included in the second layer may be included in the reference picture list of the first layer.

In addition, when the value of the dependency information indicating whether the first layer refers to the second layer is 1 and the type of the first layer and the type of the second layer are both the depth images, the pictures included in the second layer may be included in the reference picture list of the first layer.

The video decoding apparatus 20 may reconstruct the current image included in the first layer by using the pictures included in the reference picture list of the first layer. For example, the video decoding apparatus 20 may reconstruct the current image by detecting a picture corresponding to the current image, from among the pictures included in the reference picture list of the first layer, and performing motion compensation, inter-layer prediction, or disparity compensation. However, one or more embodiments are not limited thereto, that is, the video decoding apparatus 20 may reconstruct the current image included in the first layer by using the pictures included in the reference picture list of the first layer in various ways.

The multi-layer video decoding apparatus 20 according to the embodiment may include a central processor (not shown) that controls both the obtainer 22 and the decoder 24. Alternatively, the obtainer 22 and the decoder 24 are driven by their own processors (not shown), and the processors (not shown) may operate in association with each other to generally control the multi-layer video decoding apparatus 20. Alternatively, the obtainer 22 and the decoder 24 may be controlled by an external processor (not shown) of the multi-layer video decoding apparatus 20.

The multi-layer video decoding apparatus 20 may include one or more data storages (not shown) in which input/output data of the obtainer 22 and the decoder 24 is stored. The multi-layer video decoding apparatus 20 may include a memory controller (not shown) that controls data input/output to/from the data storages (not shown).

The multi-layer video decoding apparatus 20 operates in association with a video encoding processor mounted therein or an external video encoding processor in order to output a result of decoding video, and then, the video decoding operation including transformation may be performed. The internal video decoding processor of the multi-layer video decoding apparatus 20 may implement the video decoding operations as a separate processor. In addition, the multi-layer video decoding apparatus 20 or a central operator and a graphic operator include the video encoding processing module so as to implement basic video decoding operations.

FIG. 3A illustrates an inter-layer prediction structure according to an embodiment.

The multi-layer video encoding apparatus 10 according to an embodiment may prediction-encode base view images, left view images, and right view images according to a reproduction order 50 of a multiview video prediction structure of FIG. 3A.

According to an embodiment, the base view images, the left view images, and the right view images may respectively correspond to images of different layers from one another. For example, the base view may correspond to a first layer, the left view may correspond to a second layer, and the right view may correspond to a third layer.

According to the reproduction order 50 of the multiview video prediction structure according to a related technology, images of the same view are arranged in a horizontal direction. Accordingly, the left view images indicated by ‘Left’ are arranged in the horizontal direction in a row, the base view images indicated by ‘Center’ are arranged in the horizontal direction in a row, and the right view images indicated by ‘Right’ are arranged in the horizontal direction in a row. Compared to the left/right view images, the base view images may be central view images.

Also, images having the same POC order are arranged in a vertical direction. A POC order of images indicates a reproduction order of images forming a video. ‘POC X’ indicated in the reproduction order 50 of the multiview video prediction structure indicates a relative reproduction order of images in a corresponding column, wherein a reproduction order is in front when a value of X is low, and is behind when the value of X is high.

Thus, according to the reproduction order 50 of the multiview video prediction structure according to the related technology, the left view images indicated by ‘Left’ are arranged in the horizontal direction according to the POC order (reproduction order), the base view images indicated by ‘Center’ are arranged in the horizontal direction according to the POC order (reproduction order), and the right view images indicated by ‘Right’ are arranged in the horizontal direction according to the POC order (reproduction order). Also, the left view image and the right view image located on the same column as the base view image have different views but the same POC order (reproduction order).

Four consecutive images form one group of pictures (GOP) according to views. Each GOP includes images between consecutive anchor pictures, and one anchor picture (key picture).

An anchor picture is a random access point, and when a reproduction location is arbitrarily selected from images arranged according to a reproduction order, i.e., a POC order, while reproducing a video, an anchor picture closest to the reproduction location according to the POC order is reproduced. The base layer images include base layer anchor pictures 51, 52, 53, 54, and 55, the left view images include left view anchor pictures 131, 132, 133, 134, and 135, and the right view images include right view anchor pictures 231, 232, 233, 234, and 235.

Multiview images may be reproduced and predicted (reconstructed) according to a GOP order. First, according to the reproduction order 50 of the multiview video prediction structure, images included in GOP 0 may be reproduced, and then images included in GOP 1 may be reproduced, according to views. In other words, images included in each GOP may be reproduced in an order of GOP 0, GOP 1, GOP 2, and GOP 3. Also, according to a coding order of the multiview video prediction structure, the images included in GOP 1 may be predicted (reconstructed), and then the images included in GOP 1 may be predicted (reconstructed), according to views. In other words, the images included in each GOP may be predicted (reconstructed) in an order of GOP 0, GOP 1, GOP 2, and GOP 3.

According to the reproduction order 50 of the multiview video prediction structure, inter-view prediction (inter-layer prediction) and inter prediction are performed on images. In the multiview video prediction structure, an image where an arrow starts is a reference image, and an image where an arrow ends is an image predicted by using a reference image.

A prediction result of base view images may be encoded and then output in a form of a base view imagestream, and a prediction result of additional view images may be encoded and then output in a form of a layer bitstream. Also, a prediction encoding result of left view images may be output as a first layer bitstream, and a prediction encoding result of right view images may be output as a second layer bitstream.

Only inter-prediction is performed on base view images. In other words, the base layer anchor pictures 51, 52, 53, 54, and 55 of an I-picture type do not refer to other images, but remaining images of B- and b-picture types are predicted by referring to other base view images. Images of a B-picture type are predicted by referring to an anchor picture of an I-picture type, which precedes the images of a B-picture type according to a POC order, and a following anchor picture of an I-picture type. Images of a b-picture type are predicted by referring to an anchor picture of an I-type, which precedes the image of a b-picture type according a POC order, and a following image of a B-picture type, or by referring to an image of a B-picture type, which precedes the images of a b-picture type according to a POC order, and a following anchor picture of an I-picture type.

Inter-view prediction (inter-layer prediction) that refers to different view images, and inter prediction that refers to same view images are performed on each of left view images and right view images.

Inter-view prediction (inter-layer prediction) may be performed on the left view anchor pictures 131, 132, 133, 134, and 135 by respectively referring to the base view anchor pictures 51, 52, 53, 54, and 55 having the same POC order. Inter-view prediction may be performed on the right view anchor pictures 231, 232, 233, 234, and 235 by respectively referring to the base view anchor pictures 51, 52, 53, 54, and 55 or the left view anchor pictures 131, 132, 133, 134, and 135 having the same POC order. Also, inter-view prediction (inter-layer prediction) may be performed on remaining images other than the left view images 131, 132, 133, 134, and 135 and the right view images 231, 232, 233, 234, and 235 by referring to other view images having the same POC.

Remaining images other than the anchor pictures 131, 132, 133, 134, and 135 and 231, 232, 233, 234, and 235 from among left view images and right view images are predicted by referring to the same view images.

However, each of the left view images and the right view images may not be predicted by referring to an anchor picture that has a preceding reproduction order from among additional view images of the same view. In other words, in order to perform inter prediction on a current left view image, left view images excluding a left view anchor picture that precedes the current left view image in a reproduction order may be referenced. Equally, in order to perform inter prediction on a current right view image, right view images excluding a right view anchor picture that precedes the current right view image in a reproduction order may be referenced.

Also, in order to perform inter prediction on a current left view image, prediction may be performed by referring to a left view image that belongs to a current GOP but is to be reconstructed before the current left view image, instead of referring to a left view image that belongs to a GOP before the current GOP of the current left view image. The same is applied to a right view image.

The multi-layer video decoding apparatus 20 according to an embodiment may reconstruct base view images, left view images, and right view images according to the reproduction order 50 of the multiview video prediction structure of FIG. 3A.

Left view images may be reconstructed via inter-view disparity compensation that refers to base view images and inter motion compensation that refers to left view images. Right view images may be reconstructed via inter-view disparity compensation that refers to base view images and left view images, and inter motion compensation that refers to right view images. Reference images have to be reconstructed first for disparity compensation and motion compensation with respect to left view images and right view images.

For inter motion compensation of a left view image, left view images may be reconstructed via inter motion compensation that refers to a reconstructed left view reference image. For inter motion compensation of a right view image, right view images may be reconstructed via inter motion compensation that refers to a reconstructed right view reference image.

Also, for inter motion compensation of a current left view image, only a left view image that belongs to a current GOP of the current left view image but is to be reconstructed before the current left view image may be referenced, and a left view image that belongs to a GOP before the current GOP is not referenced. The same is applied to a right view image.

Also, the multi-layer video decoding apparatus 20 according to an embodiment may not only perform disparity compensation (or inter-layer prediction compensation) so as to encode or decode a multiview image, but may also perform motion compensation between images (or inter-layer motion prediction and compensation) via inter-view motion vector prediction.

FIG. 3B illustrates a multi-layer video according to an embodiment.

In order to provide optimal services in various network environments and various terminals, the multi-layer video encoding apparatus 10 may output a scalable bitstream by encoding multi-layer image sequences having various spatial resolutions, various quality, various frame-rates, and different views. That is, the multi-layer video encoding apparatus 10 may encode input images according to various scalability types to generate and output scalable video bitstreams. The scalability may include temporal scalability, spatial scalability, multiview scalability, and a combination thereof. Such above scalabilities may be classified according to types thereof. Also, the scalabilities may be classified by dimension identifies in each type.

For example, scalabilities have scalability types such as temporal, spatial, quality, and multiview scalabilities. In addition, according to each type, the scalabilities may be classified by scalability level identifiers. For example, the scalabilities of different types may have different level identifiers. For example, high scalability level may be aligned to high level scalability in a corresponding scalability type.

When a bitstream may be partitioned into valid substreams, the bitstream is referred to as a scalable bitstream. A spatially scalable bitstream includes substreams of various resolutions. In order to distinguish different scalabilities from each other in a same scalability type, a scalability level is used. The scalability level may be expressed as a scalability level identifier.

For example, a spatially scalable bitstream may be partitioned into substreams having different resolutions, e.g., QVGA, VGA, and WVGA. For example, layers having different resolutions from each other may be identified by using a level identifier. For example, a QVGA substream may have a spatial scalability level identifier having a value of 0, a VGA substream may have a spatial scalability level identifier having a value of 1, and a WVGA substream may have a spatial scalability level identifier having a value of 2.

A temporal scalable bitstream includes substreams having various frame rates. For example, the temporally scalable bitstream may be partitioned into substreams having a frame rate of 7.5 Hz, a frame rate of 15 Hz, a frame rate of 30 Hz, and a frame rate of 60 Hz. A quality scalable bitstream may be partitioned into substreams having different quality from each other according to a coarse-grained scalability (CGS) method, a medium-grained scalability (MGS) method, and a fine-grained scalability (FGS) method. The temporal scalability may be classified as different levels according to different frame rates, and the quality scalability may be classified as different levels according to different methods.

A multiview scalable bitstream includes substreams of different views in one bitstream. For example, in a stereoscopic image, a bitstream includes a left image and a right image. In addition, the scalable bitstream may include substreams of encoded data of the multiview image and a depth map. The multiview scalability may be classified as different levels according to the viewpoints.

Different scalable extension types from each other may be combined with each other. That is, the scalable video bitstream may include substreams obtained by encoding image sequences of multi-layers, which include images having at least one of the temporal, spatial, quality, and multiview scalabilities different from the others.

FIG. 3B illustrates image sequences 3010, 3020, and 3030 having different scalable extension types. A first layer image sequence 3010, a second layer image sequence 3020, and an n-th (n is an integer) layer image sequence 3030 may each have at least one of a resolution, quality, and view different from those of the others. In addition, one of the first layer image sequence 3010, the second layer image sequence 3020, and the n-th (n is an integer) layer image sequence 3030 may be a base layer image sequence, and the other layer image sequences may be image sequences of enhancement layers.

As an example, the first layer image sequence 3010 may include images of a first view, the second layer image sequence 3020 may include images of a second view, and the n-th layer image sequence 3030 may include images of n-th view. As another example, the first layer image sequence 3010 may include left view images of a base layer, the second layer image sequence 3020 may include right view images of the base layer, and the n-th layer image sequence 3030 may include right view images of an enhancement layer. One or more embodiments are not limited thereto, the image sequences 3010, 3020, and 3030 having different scalable expansion types may be sequences of the images having different image attributes.

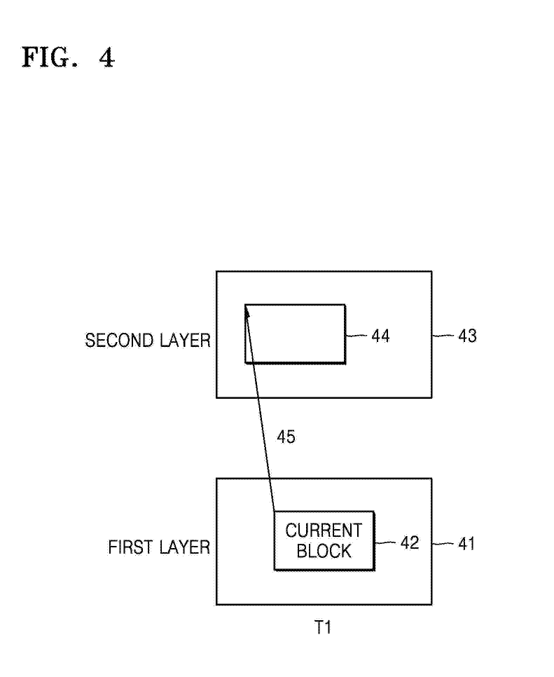

FIG. 4 is a diagram illustrating disparity compensation according to an embodiment.

According to an embodiment, the multi-layer video decoding apparatus 20 may restrict a reference picture list of a first layer, which includes a current block 42. For example, the multi-layer decoding apparatus 20 may not include pictures of different type from the first layer including the current block 42 in the reference picture list.

For example, when the first layer includes texture images, the video decoding apparatus 20 may not include depth images in the reference picture list of the first layer.

In addition, when the first layer includes depth images, the video decoding apparatus 20 may not include texture images in the reference picture list of the first layer.

According to an embodiment, the multi-layer video decoding apparatus 20 may detect a second layer picture 43 corresponding to a current picture 41, from among pictures included in the reference picture list of the first layer including the current block 42.

Referring to FIG. 4, the multi-layer video decoding apparatus 20 may perform disparity compensation on the current block by using a disparity vector. The disparity compensation denotes execution of a motion compensation on the current image, by referring to the layer including the current image and images included in other layers.

For example, the multi-layer video decoding apparatus 20 may detect a second layer block 44 corresponding to the current block 42 in a second layer picture 43 corresponding to the current picture 41, by using a location of the current block 42 and a disparity vector 45.

The multi-layer video decoding apparatus 20 may obtain a prediction block by using the detected second layer block 44. In addition, a first layer current block may be reconstructed by synthesizing residual data obtained from a bitstream with the prediction block.

One or more embodiments are not limited the above example, that is, the multi-layer video decoding apparatus 20 may reconstruct a current image by referring to images included in a current layer and other layers in various ways.

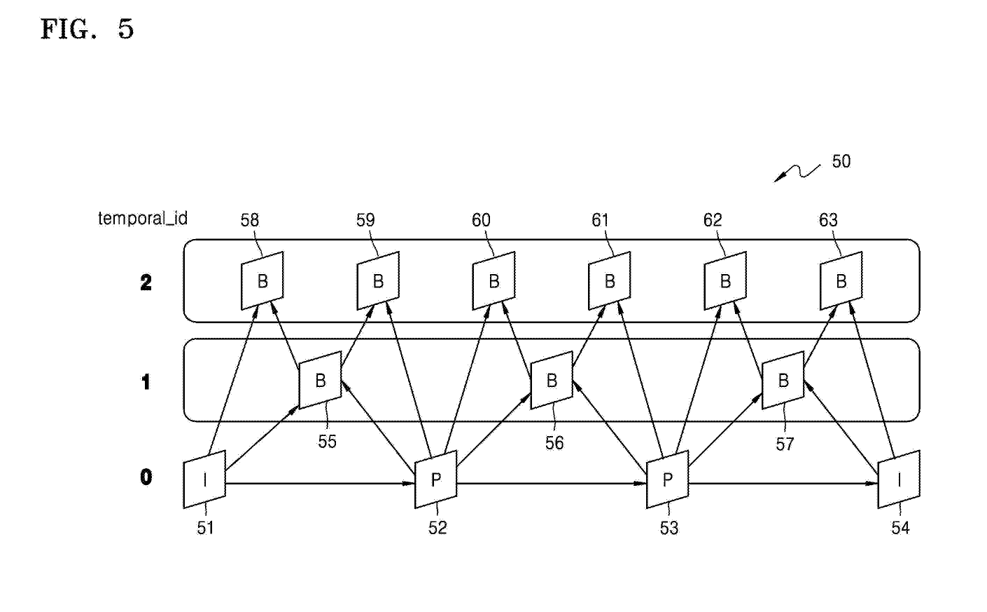

FIG. 5 illustrates a multi-layer prediction structure according to encoding/decoding methods using a temporal sub-layer.

A scalable video coding method may be performed according to a temporal hierarchical structure 50. The temporal hierarchical structure 50 includes a prediction structure of hierarchical B type images 55, 56, 57, 58, 59, 60, 61, 62, and 63. In a prediction structure of level 0, an inter-prediction of I type images 51 and 54 and an inter-prediction of P type images 52 and 53 are performed. In a prediction structure of level 1, an inter-prediction of B type images 55, 56, and 57 referring to the I and P type images 51, 52, 53, and 54 is performed. In a prediction structure of level 2, an inter-prediction is performed by referring to the I and P type images 51, 52, 53, and 54 and the B type images 55, 56, and 57 of the level 1.

Temporal indexes ‘temporal_id’ are numbers for identifying the prediction levels, and as images of each level are output, a frame rate may increase. For example, the images 51, 52, 53, and 54 of the level 0 are decoded and output with a frame rate of 15 Hz, and when the images 55, 56, and 57 of the level 1 are decoded and output, the frame rate increases to 30 Hz. In addition, when the images 58, 59, 60, 61, 62, and 63 of the level 2 are decoded and output, the frame rate may increase to 60 Hz.

According to an embodiment, when the temporal hierarchical structure 50 is implemented in the scalable video coding method, the images of the level 0 may be encoded as base layer images, the images of level 1 may be encoded as first enhancement layer images, and the images of level 2 may be encoded as second enhancement layer images.

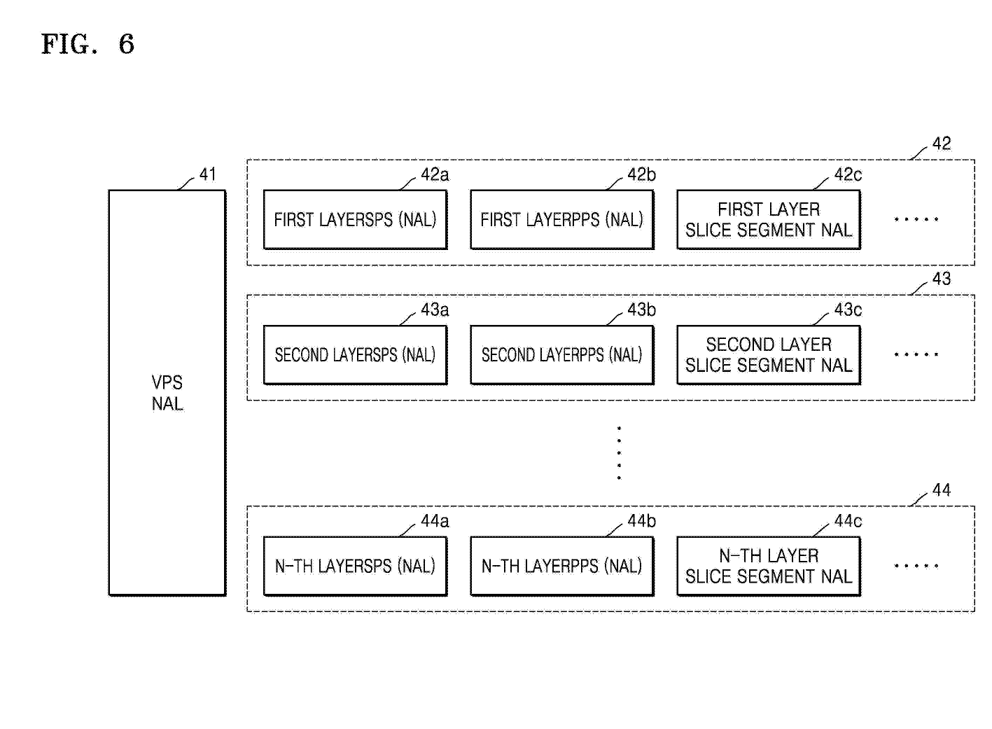

FIG. 6 illustrates network abstraction layer (NAL) units including encoded data of a multi-layer video, according to an embodiment.

As described above, the bitstream generator 18 outputs NAL units, each including encoded multi-layer video data and additional information. A video parameter set (VPS) includes information applied to multi-layer image sequences included in the multi-layer video. NAL units including information about the VPS are referred to as VPS NAL units 41.

Each of the VPS NAL unit 41 may include a common syntax element shared by the multi-layer image sequences, information about an operation point for preventing unnecessary information from being transferred, and essential information about an operation point that is necessary in a session negotiation such as a profile or a level. In particular, the VPS NAL unit 41 according to an embodiment includes scalability information regarding scalability identifiers for implementing the scalability in a multi-layer video. The scalability information is information for determining scalability applied to the multi-layer image sequences included in the multi-layer video.

The scalability information may include information about scalability type and scalability level applied to multi-layer image sequences included in a multi-layer video. According to the encoding/decoding methods according to a first embodiment, the scalability information may be directly obtained from a value of a level identifier included in a NAL unit header. The level identifier is an identifier for distinguishing a plurality of layers included in the VPS. The VPS may perform signalling of the level identifier with respect to each layer via a VPS extension. The level identifier of each layer in the VPS may be signalled after being included in the VPS NAL unit. For example, a level identifier of the NAL units included in a certain layer of the VPS may be included in the VPS NAL unit. For example, the level identifier of the NAL unit included in the VPS may be signalled via a VPS extension. Therefore, in the encoding/decoding methods according to the embodiment, scalability information about layers of the NAL units included in a corresponding VPS may be obtained by using a level identifier value of the corresponding NAL units.

According to the embodiment, dependency information between layers and type information of each layer may be included in a VPS NAL unit 41 or a VPS extension.

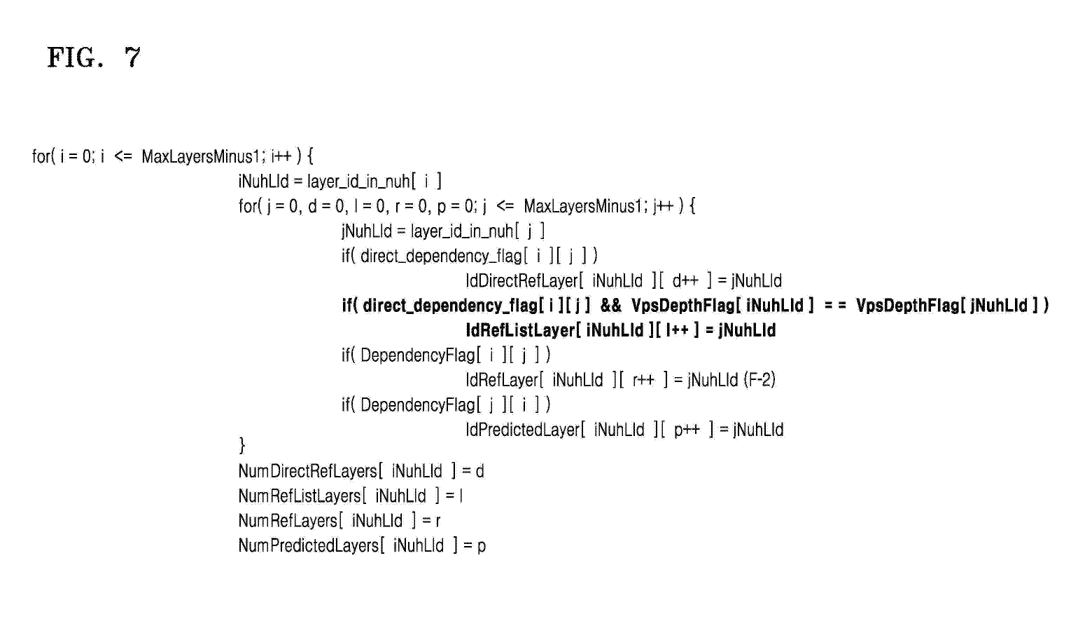

FIG. 7 illustrates a method of configuring a reference picture set and/or a reference picture list by using type information according to an embodiment.

The multi-layer video decoding apparatus 20 may obtain dependency information (direct_dependency_flag) indicating references between some of a plurality of layers.

For example, the multi-layer video decoding apparatus 20 may obtain first dependency information (direct_dependency_flag[1][2]) indicating whether a first layer refers to a second layer. In addition, the multi-layer video decoding apparatus 20 may obtain second dependency information (direct_dependency_flag[1][3]) indicating dependency between the first layer and a third layer.

The multi-layer video decoding apparatus 20 may obtain type information VpsDepthFag of each of layers. The multi-layer video decoding apparatus 20 may obtain the dependency information VpsDepthFlag from a bitstream. In addition, the multi-layer video decoding apparatus 20 may induce the dependency information VpsDepthFlag based on predetermined information obtained from a bitstream.

The multi-layer video decoding apparatus 20 may generate reference list layer information IdRefListLayer. The reference list layer information IdRefListLayer denotes information used to generate a reference picture set and/or a reference picture list.

For example, the multi-layer video decoding apparatus 20 may allow pictures of a layer included in reference list layer information IdRefListLayer of a layer including a current image to be included in a reference picture set and/or reference picture list of the layer including the current image.

The multi-layer video decoding apparatus 20 may generate the reference list layer information IdRefListLayer based on whether the dependency information direct_dependency_flag between the layers and the type information VpsDepthFlag of each layer are the same as each other.

For example, when a value of the dependency information direct_dependency_flag indicating whether the first layer refers to the second layer is 1 and a value of type information VpsDepthFlag[1] of the first layer and a value of type information VpsDepthFlag[2] of the second layer are the same as each other, the multi-layer video decoding apparatus 20 may allow the reference list layer information IdRefListLayer of the first layer to include the second layer. In this case, the multi-layer video decoding apparatus 20 may include pictures of the second layer in the reference picture set and/or the reference picture list of the first layer, when generating the reference picture set and/or the reference picture list of the first layer.

In addition, for example, when the value of the dependency information direct_dependency_flag indicating whether the first layer refers to the second layer and the value of the type information VpsDepthFlag[1] of the first layer and the value of the type information VpsDepthFlag[2] of the second layer are different from each other, the multi-layer video decoding apparatus 20 may not include the second layer in the reference list layer information IdRefListLayer of the first layer. In this case, the multi-layer video decoding apparatus 20 may not include the pictures of the second layer in the reference picture set and/or the reference picture list of the first layer, when generating the reference picture set and/or the reference picture list of the first layer.

As described above, the multi-layer video encoding apparatus 10 according to various embodiments and the multi-layer video decoding apparatus 20 according to various embodiments may spilt blocks of video data into coding units having a tree structure, and coding units, prediction units, and transformation units may be used for inter-layer prediction or inter prediction of coding units. Hereinafter, with reference to FIGS. 8 through 20, a video encoding method, a video encoding apparatus, a video decoding method, and a video decoding apparatus based on coding units having a tree structure and transformation units, according to various embodiments, will be described.

In principle, during encoding and decoding processes for a multi-layer video, encoding and decoding processes for first layer images and encoding and decoding processes for second layer images are separately performed. In other words, when inter-layer prediction is performed on a multi-layer video, encoding and decoding results of single-layer videos may be mutually referred to, but separate encoding and decoding processes are performed according to single-layer videos.

Accordingly, since video encoding and decoding processes based on coding units having a tree structure as described below with reference to FIGS. 8 through 20 for convenience of description are video encoding and decoding processes for processing a single-layer video, only inter prediction and motion compensation are performed. However, as described above with reference to FIGS. 1A through 7, in order to encode and decode a video stream, inter-layer prediction and compensation are performed on base layer images and second layer images.

Accordingly, in order for the encoder 12 of the multi-layer video encoding apparatus 10 according to various embodiments to encode a multi-layer video based on coding units having a tree structure, the inter-layer video encoding apparatus 10 may include as many video encoding apparatuses 100 of FIG. 8 as the number of layers of the multi-layer video so as to perform video encoding according to each single-layer video, thereby controlling each video encoding apparatus 100 to encode an assigned single-layer video. Also, the multi-layer video encoding apparatus 10 may perform inter-view prediction by using encoding results of individual single viewpoints of each video encoding apparatus 100. Accordingly, the encoder 12 of the multi-layer video encoding apparatus 10 may generate a base view video stream and a second layer video stream, which include encoding results according to layers.

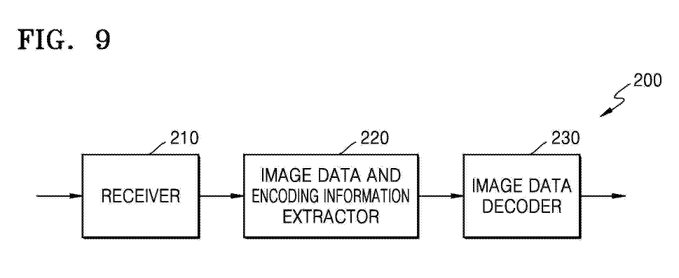

Similarly, in order for the decoder 24 of the multi-layer video decoding apparatus 20 according to various embodiments to decode a multi-layer video based on coding units having a tree structure, the multi-layer video decoding apparatus 20 may include as many video decoding apparatuses 200 of FIG. 9 as the number of layers of the multi-layer video so as to perform video decoding according to layers with respect to a received first layer video stream and a received second layer video stream, thereby controlling each video decoding apparatus 200 to decode an assigned single-layer video. Also, the multi-layer video decoding apparatus 20 may perform inter-layer compensation by using a decoding result of an individual single layer of each video decoding apparatus 200. Accordingly, the decoder 24 of the inter-layer video decoding apparatus 20 may generate first layer images and second layer images which are reconstructed according to layers.

FIG. 8 is a block diagram of a video encoding apparatus based on coding units according to tree structure 100, according to an embodiment of the present disclosure.

The video encoding apparatus accompanied with video prediction based on coding units according to tree structure 100 according to the embodiment includes a largest coding unit splitter 110, a coding unit determiner 120 and an output unit 130. Hereinafter, for convenience of description, the video encoding apparatus accompanied with video prediction based on coding units according to tree structure 100 according to the embodiment will be abbreviated to the ‘video encoding apparatus 100’.

The coding unit determiner 120 may split a current picture based on a largest coding unit that is a coding unit having a maximum size for a current picture of an image. If the current picture is larger than the largest coding unit, image data of the current picture may be split into the at least one largest coding unit. The largest coding unit according to various embodiments may be a data unit having a size of 32×32, 64×64, 128×128, 256×256, etc., wherein a shape of the data unit is a square having a width and length in squares of 2.

A coding unit according to various embodiments may be characterized by a maximum size and a depth. The depth denotes the number of times the coding unit is spatially split from the largest coding unit, and as the depth deepens, deeper coding units according to depths may be split from the largest coding unit to a minimum coding unit. A depth of the largest coding unit is an uppermost depth and a depth of the minimum coding unit is a lowermost depth. Since a size of a coding unit corresponding to each depth decreases as the depth of the largest coding unit deepens, a coding unit corresponding to an upper depth may include a plurality of coding units corresponding to lower depths.

As described above, the image data of the current picture is split into the largest coding units according to a maximum size of the coding unit, and each of the largest coding units may include deeper coding units that are split according to depths. Since the largest coding unit according to various embodiments is split according to depths, the image data of a spatial domain included in the largest coding unit may be hierarchically classified according to depths.

A maximum depth and a maximum size of a coding unit, which limit the total number of times a height and a width of the largest coding unit are hierarchically split, may be predetermined.

The coding unit determiner 120 encodes at least one split region obtained by splitting a region of the largest coding unit according to depths, and determines a depth to output a finally encoded image data according to the at least one split region. In other words, the coding unit determiner 120 determines a final depth by encoding the image data in the deeper coding units according to depths, according to the largest coding unit of the current picture, and selecting a depth having the least encoding error. The determined final depth and the encoded image data according to the determined coded depth are output to the output unit 130.

The image data in the largest coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one final depth may be selected for each largest coding unit.

The size of the largest coding unit is split as a coding unit is hierarchically split according to depths, and as the number of coding units increases. Also, even if coding units correspond to the same depth in one largest coding unit, it is determined whether to split each of the coding units corresponding to the same depth to a lower depth by measuring an encoding error of the image data of the each coding unit, separately. Accordingly, even when image data is included in one largest coding unit, the encoding errors may differ according to regions in the one largest coding unit, and thus the final depths may differ according to regions in the image data. Thus, one or more final depths may be determined in one largest coding unit, and the image data of the largest coding unit may be divided according to coding units of at least one final depth.

Accordingly, the coding unit determiner 120 according to various embodiments may determine coding units having a tree structure included in the largest coding unit. The ‘coding units having a tree structure’ according to various embodiments include coding units corresponding to a depth determined to be the final depth, from among all deeper coding units included in the largest coding unit. A coding unit of a final depth may be hierarchically determined according to depths in the same region of the largest coding unit, and may be independently determined in different regions. Equally, a final depth in a current region may be independently determined from a final depth in another region.

A maximum depth according to various embodiments is an index related to the number of splitting times from a largest coding unit to a minimum coding unit. A first maximum depth according to various embodiments may denote the total number of splitting times from the largest coding unit to the minimum coding unit. A second maximum depth according to various embodiments may denote the total number of depth levels from the largest coding unit to the minimum coding unit. For example, when a depth of the largest coding unit is 0, a depth of a coding unit, in which the largest coding unit is split once, may be set to 1, and a depth of a coding unit, in which the largest coding unit is split twice, may be set to 2. In this regard, if the minimum coding unit is a coding unit in which the largest coding unit is split four times, depth levels of depths 0, 1, 2, 3, and 4 exist, and thus the first maximum depth may be set to 4, and the second maximum depth may be set to 5.

Prediction encoding and transformation may be performed according to the largest coding unit. The prediction encoding and the transformation are also performed based on the deeper coding units according to a depth equal to or depths less than the maximum depth, according to the largest coding unit.

Since the number of deeper coding units increases whenever the largest coding unit is split according to depths, encoding, including the prediction encoding and the transformation, is performed on all of the deeper coding units generated as the depth deepens. For convenience of description, the prediction encoding and the transformation will now be described based on a coding unit of a current depth, in a largest coding unit.

The video encoding apparatus 100 according to various embodiments may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the largest coding unit, the prediction encoding may be performed based on a coding unit corresponding to a final depth according to various embodiments, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition mode according to various embodiments may selectively include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, or partitions having arbitrary shapes.

A prediction mode of the prediction unit may be at least one of an intra mode, a inter mode, and a skip mode. For example, the intra mode and the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 according to various embodiments may perform not only the transformation on the image data in a coding unit based on the coding unit for encoding the image data, but also may perform the transformation on the image data based on a data unit that is different from the coding unit. In order to perform the transformation in the coding unit, the transformation may be performed based on a transformation unit having a size less than or equal to the coding unit. For example, the transformation unit may include a data unit for an intra mode and a transformation unit for an inter mode.

The transformation unit in the coding unit may be recursively split into smaller sized regions in a manner similar to that in which the coding unit is split according to the tree structure, according to various embodiments. Thus, residual data in the coding unit may be split according to the transformation unit having the tree structure according to transformation depths.

A transformation depth indicating the number of splitting times to reach the transformation unit by splitting the height and width of the coding unit may also be set in the transformation unit according to various embodiments. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Split information according to depths requires not only information about a depth but also requires information related to prediction encoding and transformation. Accordingly, the coding unit determiner 120 not only determines a depth having a least encoding error, but also determines a partition mode of splitting a prediction unit into a partition, a prediction mode according to prediction units, and a size of a transformation unit for transformation.

Coding units according to a tree structure in a largest coding unit and methods of determining a prediction unit/partition, and a transformation unit, according to various embodiments, will be described in detail later with reference to FIGS. 9 through 19.

The coding unit determiner 120 may measure an encoding error of deeper coding units according to depths by using Rate-Distortion Optimization based on Lagrangian multipliers.

The output unit 130 outputs the image data of the largest coding unit, which is encoded based on the at least one depth determined by the coding unit determiner 120, and split information according to the depth, in bitstreams.

The encoded image data may be obtained by encoding residual data of an image.

The split information according to depth may include information about the depth, about the partition mode in the prediction unit, about the prediction mode, and about split of the transformation unit.

The information about the final depth may be defined by using split information according to depths, which indicates whether encoding is performed on coding units of a lower depth instead of a current depth. If the current depth of the current coding unit is a depth, the current coding unit is encoded, and thus the split information may be defined not to split the current coding unit to a lower depth. Alternatively, if the current depth of the current coding unit is not the depth, the encoding is performed on the coding unit of the lower depth, and thus the split information may be defined to split the current coding unit to obtain the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one largest coding unit, and split information is determined for a coding unit of a depth, at least one piece of split information may be determined for one largest coding unit. Also, a depth of the image data of the largest coding unit may be different according to locations since the image data is hierarchically split according to depths, and thus a depth and split information may be set for the image data.

Accordingly, the output unit 130 according to various embodiments may assign a corresponding depth and encoding information about an encoding mode to at least one of the coding unit, the prediction unit, and a minimum unit included in the largest coding unit.

The minimum unit according to various embodiments is a square data unit obtained by splitting the minimum coding unit constituting the lowermost depth by 4. Alternatively, the minimum unit according to various embodiments may be a maximum square data unit that may be included in all of the coding units, prediction units, partition units, and transformation units included in the largest coding unit.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The output unit 130 may encode and output reference information related to prediction, motion information, and slice type information.

In the video encoding apparatus 100 according to the simplest embodiment, the deeper coding unit may be a coding unit obtained by dividing a height or width of a coding unit of an upper depth, which is one layer above, by two. That is, when the size of the coding unit of the current depth is 2N×2N, the size of the coding unit of the lower depth is N×N. Also, the coding unit with the current depth having a size of 2N×2N may include a maximum of 4 of the coding units with the lower depth of N×N.

Accordingly, the video encoding apparatus 100 may form the coding units having the tree structure by determining coding units having an optimum shape and an optimum size for each largest coding unit, based on the size of the largest coding unit and the maximum depth determined considering characteristics of the current picture. Also, since encoding may be performed on each largest coding unit by using any one of various prediction modes and transformations, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100 according to various embodiments, image compression efficiency may be increased since a coding unit is adjusted while considering characteristics of an image while increasing a maximum size of a coding unit while considering a size of the image.

The multi-layer video encoding apparatus 10 described above with reference to FIG. 1A may include as many video encoding apparatuses 100 as the number of layers, in order to encode single-layer images according to layers of a multi-layer video.

When the video encoding apparatus 100 encodes first layer images, the coding unit determiner 120 may determine, for each largest coding unit, a prediction unit for inter-prediction according to coding units having a tree structure, and may perform inter-prediction according to prediction units.

Even when the video encoding apparatus 100 encodes second layer images, the coding unit determiner 120 may determine, for each largest coding unit, coding units and prediction units having a tree structure, and may perform inter-prediction according to prediction units.

The video encoding apparatus 100 may encode a luminance difference to compensate for a luminance difference between a first layer image and a second layer image. However, whether to perform luminance may be determined according to an encoding mode of a coding unit. For example, luminance compensation may be performed only on a prediction unit having a size of 2N×2N.

FIG. 9 is a block diagram of a video decoding apparatus based on coding units according to tree structure 200, according to various embodiments.

The video decoding apparatus based on coding units according to tree structure 200 according to an embodiment includes a receiver 210, an image data and encoding information extractor 220, and an image data decoder 230. For convenience of description, the video decoding apparatus accompanied with video prediction based on coding units according to tree structure 200 according to an embodiment will be abbreviated to the ‘video decoding apparatus 200’.

Definitions of various terms, such as a coding unit, a depth, a prediction unit, a transformation unit, and various split information, for decoding operations of the video decoding apparatus 200 according to various embodiments are identical to those described with reference to FIG. 8 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each largest coding unit, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts a final depth and split information for the coding units having a tree structure according to each largest coding unit, from the parsed bitstream. The extracted final depth and split information are output to the image data decoder 230. That is, the image data in a bit stream is split into the largest coding unit so that the image data decoder 230 decodes the image data for each largest coding unit.

A depth and split information according to the largest coding unit may be set for at least one piece of depth information, and split information may include information about a partition mode of a corresponding coding unit, about a prediction mode, and about split of a transformation unit. Also, split information according to depths may be extracted as the information about a depth.

The depth and the split information according to each largest coding unit extracted by the image data and encoding information extractor 220 is a depth and split information determined to generate a minimum encoding error when an encoder, such as the video encoding apparatus 100 according to various embodiments, repeatedly performs encoding for each deeper coding unit according to depths according to each largest coding unit. Accordingly, the video decoding apparatus 200 may reconstruct an image by decoding the image data according to a coded depth and an encoding mode that generates the minimum encoding error.

Since encoding information according to various embodiments about a depth and an encoding mode may be assigned to a predetermined data unit from among a corresponding coding unit, a prediction unit, and a minimum unit, the image data and encoding information extractor 220 may extract the depth and the split information according to the predetermined data units. If the depth and the split information of a corresponding largest coding unit is recorded according to predetermined data units, the predetermined data units to which the same depth and the same split information is assigned may be inferred to be the data units included in the same largest coding unit.

The image data decoder 230 may reconstruct the current picture by decoding the image data in each largest coding unit based on the depth and the split information according to the largest coding units. In other words, the image data decoder 230 may decode the encoded image data based on the extracted information about the partition mode, the prediction mode, and the transformation unit for each coding unit from among the coding units having the tree structure included in each largest coding unit. A decoding process may include a prediction including intra prediction and motion compensation, and an inverse transformation.

The image data decoder 230 may perform intra prediction or motion compensation according to a partition and a prediction mode of each coding unit, based on the information about the partition mode and the prediction mode of the prediction unit of the coding unit according to depths.

In addition, the image data decoder 230 may read information about a transformation unit according to a tree structure for each coding unit so as to perform inverse transformation based on transformation units for each coding unit, for inverse transformation for each largest coding unit. Via the inverse transformation, a pixel value of a spatial region of the coding unit may be reconstructed.

The image data decoder 230 may determine a depth of a current largest coding unit by using split information according to depths. If the split information indicates that image data is no longer split in the current depth, the current depth is a depth. Accordingly, the image data decoder 230 may decode encoded data in the current largest coding unit by using the information about the partition mode of the prediction unit, the prediction mode, and the size of the transformation unit.

That is, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

The multi-layer video decoding apparatus 20 described above with reference to FIG. 2A may include video decoding apparatuses 200 as much as the number of viewpoints, so as to reconstruct first layer images and second layer images by decoding a received first layer image stream and a received second layer image stream.

When the first layer image stream is received, the image data decoder 230 of the video decoding apparatus 200 may split samples of first layer images extracted from the first layer image stream by the image data and encoding information extractor 220 into coding units having a tree structure. The image data decoder 230 may reconstruct the first layer images by performing motion compensation according to prediction units for inter prediction, on the coding units having the tree structure obtained by splitting the samples of the first layer images.

When the second layer image stream is received, the image data decoder 230 of the video decoding apparatus 200 may split samples of second layer images extracted from the second layer image stream by the image data and encoding information extractor 220 into coding units having a tree structure. The image data decoder 230 may reconstruct the second layer images by performing motion compensation according to prediction units for inter prediction, on the coding units obtained by splitting the samples of the second layer images.

The extractor 220 may obtain information related to a luminance error from a bitstream so as to compensate for a luminance difference between a first layer image and a second layer image. However, whether to perform luminance may be determined according to an encoding mode of a coding unit. For example, luminance compensation may be performed only on a prediction unit having a size of 2N×2N.

Thus, the video decoding apparatus 200 may obtain information about at least one coding unit that generates the minimum encoding error when encoding is recursively performed for each largest coding unit, and may use the information to decode the current picture. In other words, the coding units having the tree structure determined to be the optimum coding units in each largest coding unit may be decoded.

Accordingly, even if an image has high resolution or has an excessively large data amount, the image may be efficiently decoded and reconstructed by using a size of a coding unit and an encoding mode, which are adaptively determined according to characteristics of the image, by using optimum split information received from an encoder.

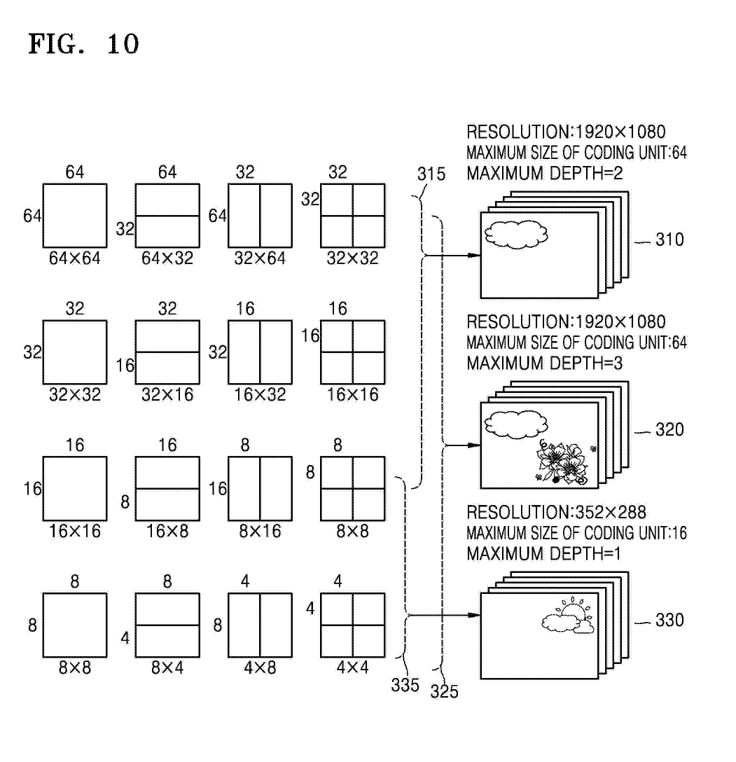

FIG. 10 is a diagram for describing a concept of coding units according to various embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 10 denotes a total number of splits from a largest coding unit to a minimum coding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a largest coding unit having a long axis size of 64, and coding units having long axis sizes of 32 and 16 since depths are deepened to two layers by splitting the largest coding unit twice. Since the maximum depth of the video data 330 is 1, coding units 335 of the video data 330 may include a largest coding unit having a long axis size of 16, and coding units having a long axis size of 8 since depths are deepened to one layer by splitting the largest coding unit once.

Since the maximum depth of the video data 320 is 3, coding units 325 of the video data 320 may include a largest coding unit having a long axis size of 64, and coding units having long axis sizes of 32, 16, and 8 since the depths are deepened to 3 layers by splitting the largest coding unit three times. As a depth deepens, detailed information may be precisely expressed.

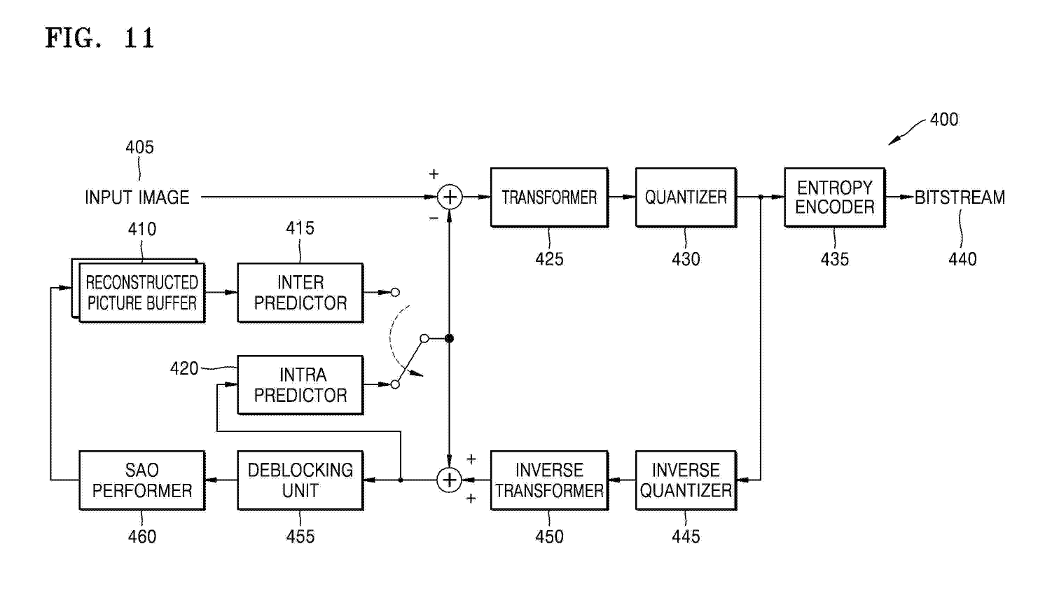

FIG. 11 is a block diagram of an image encoder 400 based on coding units, according to various embodiments.

The image encoder 400 according to various embodiments performs operations of the coding unit determiner 120 of the video encoding apparatus 100 to encode image data. In other words, an intra predictor 420 performs intra prediction on coding units in an intra mode, from among a current frame 405, per prediction unit, and an inter predictor 415 performs inter prediction on coding units in an inter mode by using the current image 405 and a reference image obtained by a reconstructed picture buffer 410, per prediction unit. The current picture 405 may be split into largest coding units, and then the largest coding units may be sequentially encoded. Here, the encoding may be performed on coding units split in a tree structure from the largest coding unit.

Residual data is generated by subtracting prediction data of a coding unit of each mode output from the intra predictor 420 or the inter predictor 415 from data of the current image 405 to be encoded, and the residual data is output as a quantized transformation coefficient through a transformer 425 and a quantizer 430 per transformation unit. The quantized transformation coefficient is reconstructed to residual data in a spatial domain through an inverse quantizer 445 and an inverse transformer 450. The residual data in the spatial domain is added to the prediction data of the coding unit of each mode output from the intra predictor 420 or the inter predictor 415 to be reconstructed as data in a spatial domain of the coding unit of the current image 405. The data in the spatial domain passes through a deblocker 455 and a sample adaptive offset (SAO) performer 460 and thus a reconstructed image is generated. The reconstructed image is stored in the reconstructed picture buffer 410. Reconstructed images stored in the reconstructed picture buffer 410 may be used as a reference image for inter prediction of another image. The quantized transformation coefficient obtained through the transformer 425 and the quantizer 430 may be output as a bitstream 440 through an entropy encoder 435.

In order for the image encoder 400 according to various embodiments to be applied in the video encoding apparatus 100, components of the image encoder 400, i.e., the inter predictor 415, the intra predictor 420, the transformer 425, the quantizer 430, the entropy encoder 435, the inverse quantizer 445, the inverse transformer 450, the deblocking unit 455, and the SAO performer 460 perform operations based on each coding unit among coding units having a tree structure per largest coding unit.

In particular, the intra predictor 420 and the inter predictor 415 may determine partitions and a prediction mode of each coding unit from among the coding units having a tree structure while considering the maximum size and the maximum depth of a current largest coding unit, and the transformer 425 may determine whether to split a transformation unit according to a quad-tree in each coding unit from among the coding units having the tree structure.

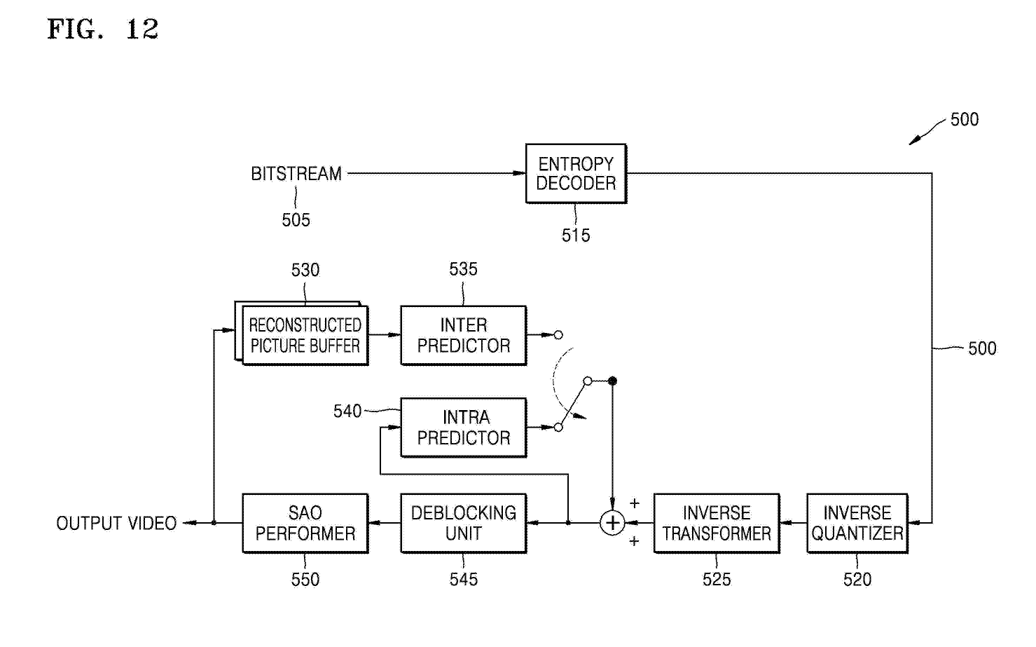

FIG. 12 is a block diagram of an image decoder 500 based on coding units according to various embodiments.

An entropy decoder 515 parses encoded image data that is to be decoded and encoding information required for decoding from a bitstream 505. The encoded image data is a quantized transformation coefficient, and an inverse quantizer 520 and an inverse transformer 525 reconstructs residual data from the quantized transformation coefficient.

An intra predictor 540 performs intra prediction on a coding unit in an intra mode according to prediction units. An inter predictor performs inter prediction on a coding unit in an inter mode from a current image according to prediction units, by using a reference image obtained by a reconstructed picture buffer 530.

Data in a spatial domain of coding units of the current image is reconstructed by adding the residual data and the prediction data of a coding unit of each mode through the intra predictor 540 or the inter predictor 535, and the data in the spatial domain may be output as a reconstructed image 560 through a deblocking unit 545 and an SAO performer 550. Also, reconstructed images that are stored in the reconstructed picture buffer 530 may be output as reference images.

In order to decode the image data in the picture decoder 230 of the video decoding apparatus 200, operations after the entropy decoder 515 of the image decoder 500 according to various embodiments may be performed.

In order for the image decoder 500 to be applied in the video decoding apparatus 200 according to various embodiments, components of the image decoder 500, i.e., the entropy decoder 515, the inverse quantizer 520, the inverse transformer 525, the intra predictor 540, the inter predictor 535, the deblocking unit 545, and the SAO performer 550 may perform operations based on coding units having a tree structure for each largest coding unit.

In particular, the intra predictor 540 and the inter predictor 535 determine a partition mode and a prediction mode according to each of coding units having a tree structure, and the inverse transformer 525 may determine whether to split a transformation unit according to a quad-tree structure per coding unit.

An encoding operation of FIG. 10 and a decoding operation of FIG. 11 are respectively a video stream encoding operation and a video stream decoding operation in a single layer. Accordingly, when the encoder 12 of FIG. 1A encodes a video stream of at least two layers, the video encoding apparatus 10 of FIG. 1A may include as many image encoder 400 as the number of layers. Similarly, when the decoder 24 of FIG. 2A decodes a video stream of at least two layers, the video decoding apparatus 20 of FIG. 2A may include as many image decoders 500 as the number of layers.

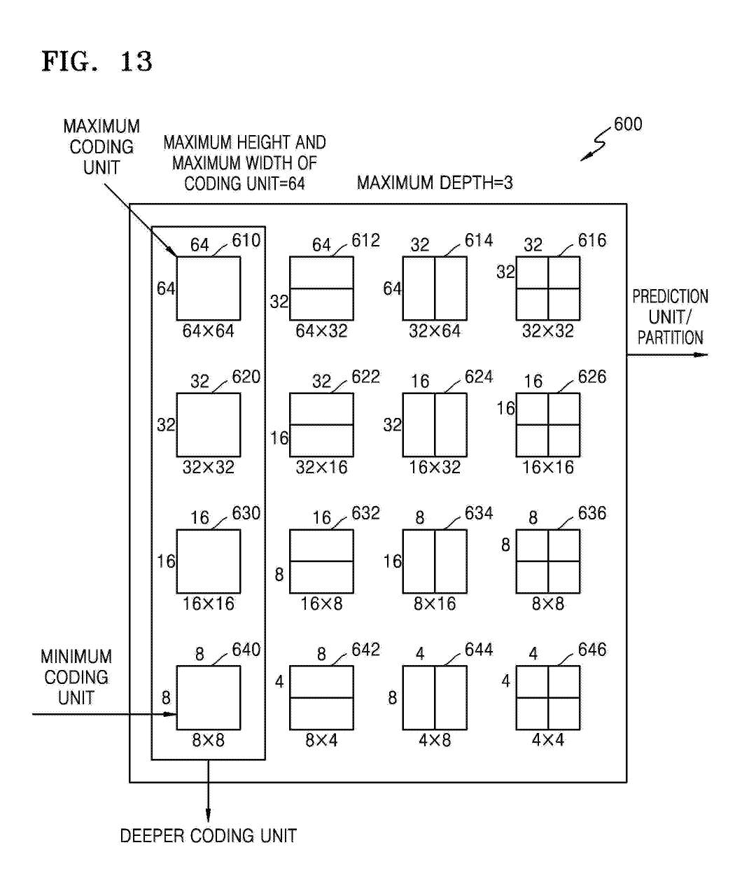

FIG. 13 is a diagram illustrating coding units according to depths and partitions, according to various embodiments.

The video encoding apparatus 100 according to various embodiments and the video decoding apparatus 200 according to various embodiments use hierarchical coding units so as to consider characteristics of an image. A maximum height, a maximum width, and a maximum depth of coding units may be adaptively determined according to the characteristics of the image, or may be variously set according to user requirements. Sizes of deeper coding units according to depths may be determined according to the predetermined maximum size of the coding unit.

In a hierarchical structure 600 of coding units according to various embodiments, the maximum height and the maximum width of the coding units are each 64, and the maximum depth is 3. In this case, the maximum depth refers to a total number of times the coding unit is split from the largest coding unit to the minimum coding unit. Since a depth deepens along a vertical axis of the hierarchical structure 600 of coding units according to various embodiments, a height and a width of the deeper coding unit are each split. Also, a prediction unit and partitions, which are bases for prediction encoding of each deeper coding unit, are shown along a horizontal axis of the hierarchical structure 600.

That is, a coding unit 610 is a largest coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having a size of 8×8 and a depth of 3 is a minimum coding unit.

The prediction unit and the partitions of a coding unit are arranged along the horizontal axis according to each depth. In other words, if the coding unit 610 having a size of 64×64 and a depth of 0 is a prediction unit, the prediction unit may be split into partitions included in the coding unit 610 having a size of 64×64, i.e. a partition 610 having a size of 64×64, partitions 612 having the size of 64×32, partitions 614 having the size of 32×64, or partitions 616 having the size of 32×32.

Equally, a prediction unit of the coding unit 620 having the size of 32×32 and the depth of 1 may be split into partitions included in the coding unit 620 having a size of 32×32, i.e. a partition 620 having a size of 32×32, partitions 622 having a size of 32×16, partitions 624 having a size of 16×32, and partitions 626 having a size of 16×16.

Equally, a prediction unit of the coding unit 630 having the size of 16×16 and the depth of 2 may be split into partitions included in the coding unit 630 having a size of 16×16, i.e. a partition having a size of 16×16 included in the coding unit 630, partitions 632 having a size of 16×8, partitions 634 having a size of 8×16, and partitions 636 having a size of 8×8.

Equally, a prediction unit of the coding unit 640 having the size of 8×8 and the depth of 3 may be split into partitions included in the coding unit 640 having a size of 8×8, i.e. a partition 640 having a size of 8×8 included in the coding unit 640, partitions 642 having a size of 8×4, partitions 644 having a size of 4×8, and partitions 646 having a size of 4×4.

In order to determine the depth of the largest coding unit 610, the coding unit determiner 120 of the video encoding apparatus 100 according to various embodiments performs encoding for coding units corresponding to each depth included in the maximum coding unit 610.

The number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the largest coding unit 610 may be selected as the depth and a partition mode of the largest coding unit 610.

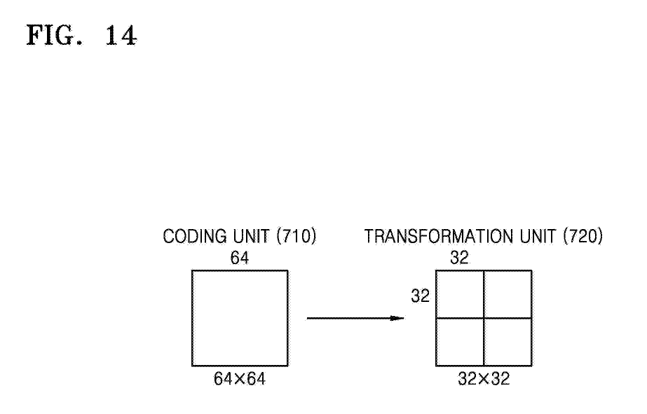

FIG. 14 is a diagram for describing a relationship between a coding unit and transformation units, according to various embodiments.

The video encoding apparatus 100 according to various embodiments or the video decoding apparatus 200 according to various embodiments encodes or decodes an image according to coding units having sizes less than or equal to a largest coding unit for each largest coding unit. Sizes of transformation units for transformation during encoding may be selected based on data units that are not larger than a corresponding coding unit.

For example, in the video encoding apparatus 100 according to various embodiments or the video decoding apparatus 200 according to various embodiments, if a size of a coding unit 710 is 64×64, transformation may be performed by using a transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

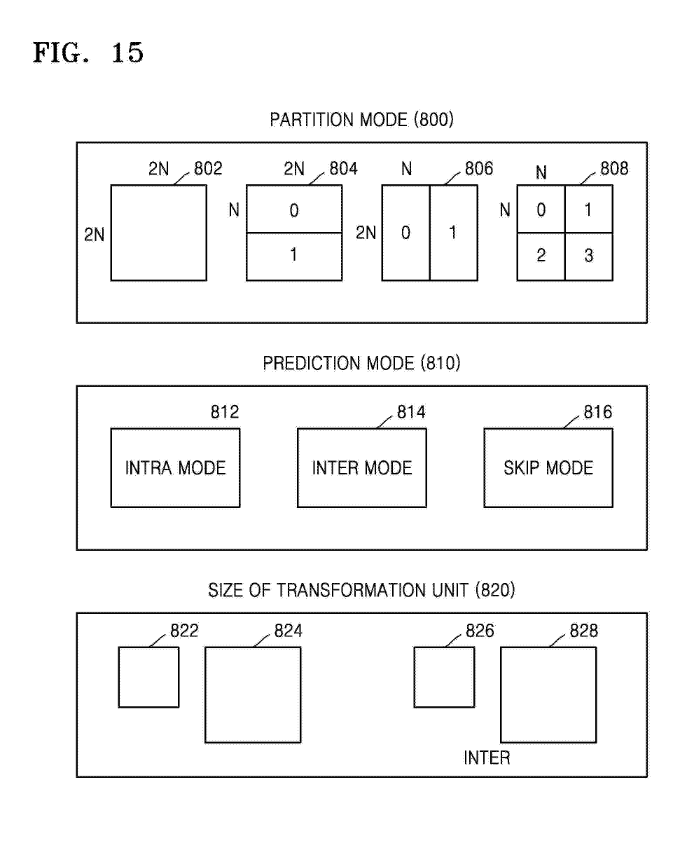

FIG. 15 illustrates a plurality of pieces of encoding information according to various embodiments.

The output unit 130 of the video encoding apparatus 100 according to various embodiments may encode and transmit information 800 about a partition mode, information 810 about a prediction mode, and information 820 about a size of a transformation unit for each coding unit corresponding to a depth, as split information.

The information 800 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

In addition, the information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 210 of the video decoding apparatus 200 according to various embodiments may extract and use the information 800, 810, and 820 for decoding, according to each deeper coding unit.

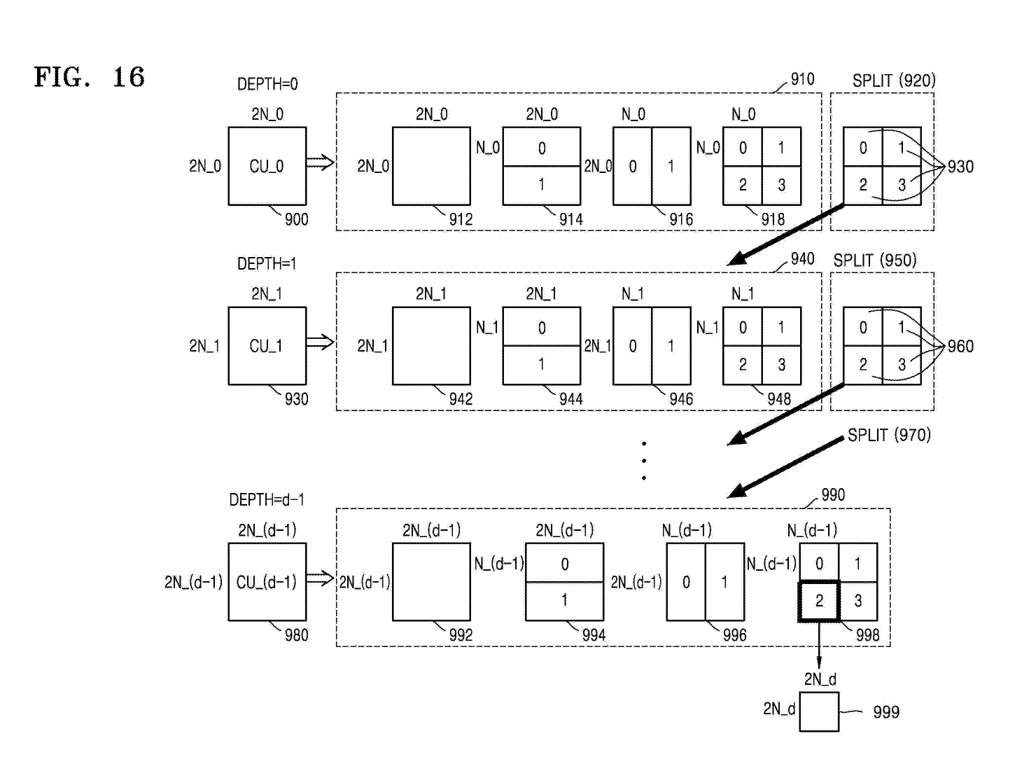

FIG. 16 is a diagram of deeper coding units according to depths, according to various embodiments.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_0×2N_0 may include partitions of a partition mode 912 having a size of 2N_0×2N_0, a partition mode 914 having a size of 2N_0×N_0, a partition mode 916 having a size of N_0×2N_0, and a partition mode 918 having a size of N_0×N_0. FIG. 9 only illustrates the partitions 912, 914, 916, and 918 which are obtained by symmetrically splitting the prediction unit, but a partition mode is not limited thereto, and the partitions of the prediction unit may include asymmetrical partitions, partitions having a predetermined shape, and partitions having a geometrical shape.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition mode. The prediction encoding in an intra mode and an inter mode may be performed on the partitions having the sizes of 2N_0×2N_0, N_0×2N_0, 2N_0×N_0, and N_0×N_0. The prediction encoding in a skip mode is performed only on the partition having the size of 2N_0×2N_0.

If an encoding error is smallest in one of the partition modes 912, 914, and 916 having sizes of 2N_0×2N_0, 2N_0×N_0, and N_0×2N_0, the prediction unit 910 may not be split into a lower depth.

If the encoding error is the smallest in the partition mode 918 having a size of N_0×N_0, a depth is changed from 0 to 1 to split the partition mode 918 in operation 920, and encoding is repeatedly performed on coding units 930 having a depth of 2 and a size of N_0×N_0 to search for a minimum encoding error.

A prediction unit 940 for prediction encoding the coding unit 930 having a depth of 1 and a size of 2N_1×2N_1 (=N_0×N_0) may include partitions of a partition mode 942 having a size of 2N_1×2N_1, a partition mode 944 having a size of 2N 1×N_1, a partition mode 946 having a size of N_1×2N_1, and a partition mode 948 having a size of N_1×N_1.

In addition, if an encoding error is the smallest in the partition mode 948 having a size of N_1×N_1, depth is changed from 1 to 2 to split the partition mode 948 in operation 950, and encoding is repeatedly performed on coding units 960, which have a depth of 2 and a size of N_2×N_2 to search for a minimum encoding error.

When a maximum depth is d, split operation according to each depth may be performed up to when a depth becomes d−1, and split information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes to search for a partition mode having a minimum encoding error.

Even when the partition mode 998 having a size N_(d−1)×N_(d−1) has the minimum encoding error, since a maximum depth is d, a coding unit CU_(d−1) having a depth of d−1 is no longer split to a lower depth, and a depth for the coding units constituting a current largest coding unit 900 is determined to be d−1 and a partition mode of the current largest coding unit 900 may be determined to be N_(d−1)×N_(d−1). Also, since the maximum depth is d, split information for a coding unit 952 having a depth of d−1 is not set.

A data unit 999 may be a ‘minimum unit’ for the current largest coding unit. A minimum unit according to various embodiments may be a square data unit obtained by splitting a minimum coding unit having a lowermost depth by 4. By performing the encoding repeatedly, the video encoding apparatus 100 according to various embodiments may select a depth having the least encoding error by comparing encoding errors according to depths of the coding unit 900 to determine a depth, and set a corresponding partition mode and a prediction mode as an encoding mode of the depth.

As such, the minimum encoding errors according to depths are compared in all of the depths of 1 through d, and a depth having the least encoding error may be determined as a d depth. The depth, the partition mode of the prediction unit, and the prediction mode may be encoded and transmitted as split information. Also, since a coding unit is split from a depth of 0 to a depth, only split information of the depth is set to 0, and split information of depths excluding the depth is set to 1.

The image data and encoding information extractor 220 of the video decoding apparatus 200 according to various embodiments may extract and use the information about the depth and the prediction unit of the coding unit 900 to decode the coding unit 912. The video decoding apparatus 200 according to various embodiments may determine a depth, in which split information is 0, as a depth by using split information according to depths, and use split information of the corresponding depth for decoding.

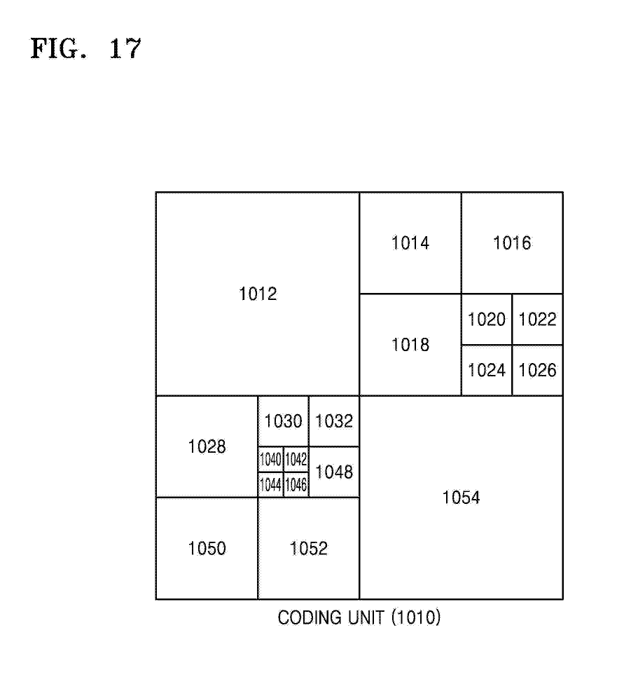

FIGS. 17, 18, and 19 are diagrams for describing a relationship between coding units, prediction units, and transformation units, according to various embodiments.

Coding units 1010 are coding units according to depths determined by the video encoding apparatus 100 according to various embodiments, in a largest coding unit. Prediction units 1060 are partitions of prediction units of each of coding units according to depths, and transformation units 1070 are transformation units of each of coding units according to depths.

When a depth of a largest coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some partitions 1014, 1016, 1022, 1032, 1048, 1050, 1052, and 1054 are obtained by splitting the coding units. In other words, partitions 1014, 1022, 1050, and 1054 are partition mode of a size of 2N×N, partitions 1016, 1048, and 1052 are partition mode of a size of N×2N, and a partition 1032 is a partition mode of a size of N×N. Prediction units and partitions of the coding units 1010 according to depths are smaller than or equal to each coding unit.

Transformation or inverse transformation is performed on image data of some 1052 in the transformation units 1070 in a data unit that is smaller than the coding unit. Also, the transformation units 1014, 1016, 1022, 1032, 1048, 1050, and 1052 are data units different from those in the prediction units 1060 in terms of sizes and shapes. In other words, the video encoding and decoding apparatuses 100 and 200 according to various embodiments may perform intra prediction, motion estimation, motion compensation, transformation, and inverse transformation on an individual data unit in the same coding unit.

Accordingly, encoding is recursively performed on each of coding units having a hierarchical structure in each region of a largest coding unit to determine an optimum coding unit, and thus coding units having a recursive tree structure may be obtained. Encoding information may include split information about a coding unit, information about a partition mode, information about a prediction mode, and information about a size of a transformation unit. Table 1 shows the encoding information that may be set by the video encoding and decoding apparatuses 100 and 200 according to various embodiments.

TABLE 1

| Split Information 0 | | | | | |
|---|---|---|---|---|---|
| (Encoding on Coding Unit having Size of 2N × 2N and Current Depth of d) | | | | | |
| | | | Size of Transformation Unit | | |
| | Partition Type | | Split | Split | |
| | Symmetrical | | Information 0 of | Information 1 of | |
| Prediction | Partition | Asymmetrical | Transformation | Transformation | Split |
| Mode | Type | Partition Type | Unit | Unit | Information 1 |
| Intra | 2N × 2N | 2N × nU | 2N × 2N | N × N | Repeatedly |
| Inter | 2N × N | 2N × nD | | (Symmetrical | Encode Coding |
| Skip (Only | N × 2N | nL × 2N | | Type) | Units having |
| 2N × 2N) | N × N | nR × 2N | | N/2 × N/2 | Lower Depth |
| | | | | (Asymmetrical | of d + 1 |
| | | | | Type) | |

The output unit 130 of the video encoding apparatus 100 according to various embodiments may output the encoding information about the coding units having a tree structure, and the image data and encoding information extractor 220 of the video decoding apparatus 200 according to various embodiments may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a depth, and thus information about a partition mode, prediction mode, and a size of a transformation unit may be defined for the depth. If the current coding unit is further split according to the split information, encoding is independently performed on four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1.

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition type of the current coding unit is an asymmetrical partition mode, the size of the transformation unit may be N/2×N/2.

The encoding information about coding units having a tree structure, according to various embodiments, may include at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a largest coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

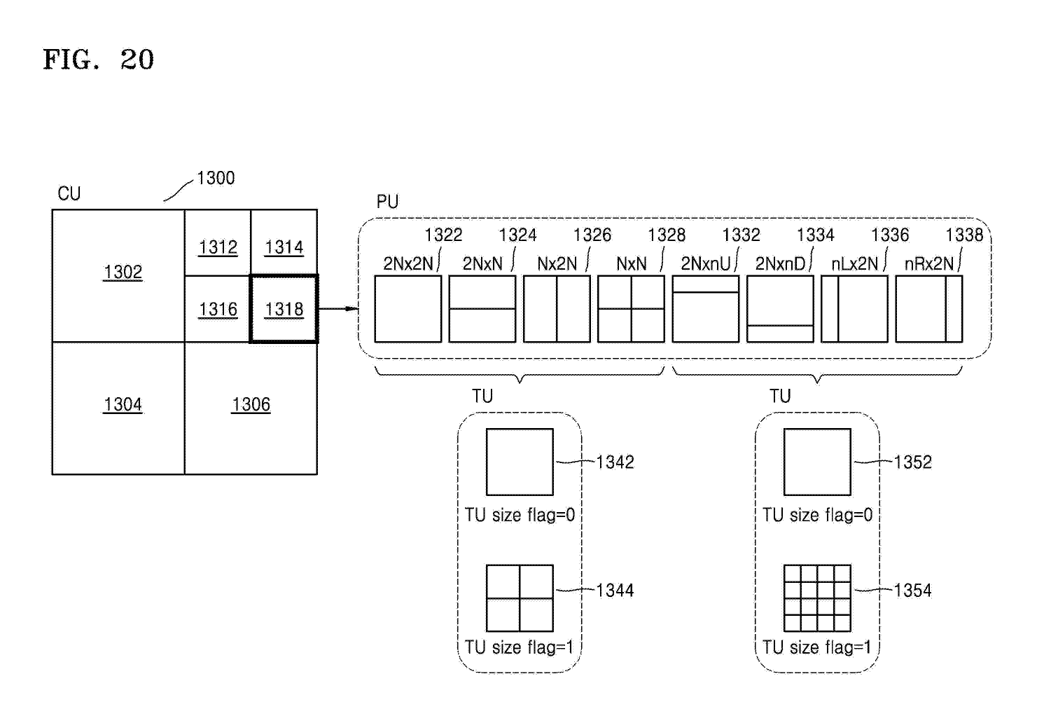

FIG. 20 is a diagram for describing a relationship between a coding unit, a prediction unit, and a transformation unit, according to encoding mode information of Table 1.

A largest coding unit 1300 includes coding units 1302, 1304, 1306, 1312, 1314, 1316, and 1318 of depths. Here, since the coding unit 1318 is a coding unit of a depth, split information may be set to 0. Information about a partition mode of the coding unit 1318 having a size of 2N×2N may be set to be one of a partition mode 1322 having a size of 2N×2N, a partition mode 1324 having a size of 2N×N, a partition mode 1326 having a size of N×2N, a partition mode 1328 having a size of N×N, a partition mode 1332 having a size of 2N×nU, a partition mode 1334 having a size of 2N×nD, a partition mode 1336 having a size of nL×2N, and a partition mode 1338 having a size of nR×2N.

Split information (TU size flag) of a transformation unit is a type of a transformation index. The size of the transformation unit corresponding to the transformation index may be changed according to a prediction unit type or partition mode of the coding unit.

For example, when the partition mode information is set to be symmetrical, i.e. the partition mode 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition mode information is set to be asymmetrical, i.e., the partition mode 1332, 1334, 1336, or 1338, a transformation unit 1352 having a size of 2N×2N is set if a TU size flag is 0, and a transformation unit 1354 having a size of N/2×N/2 is set if a TU size flag is 1.

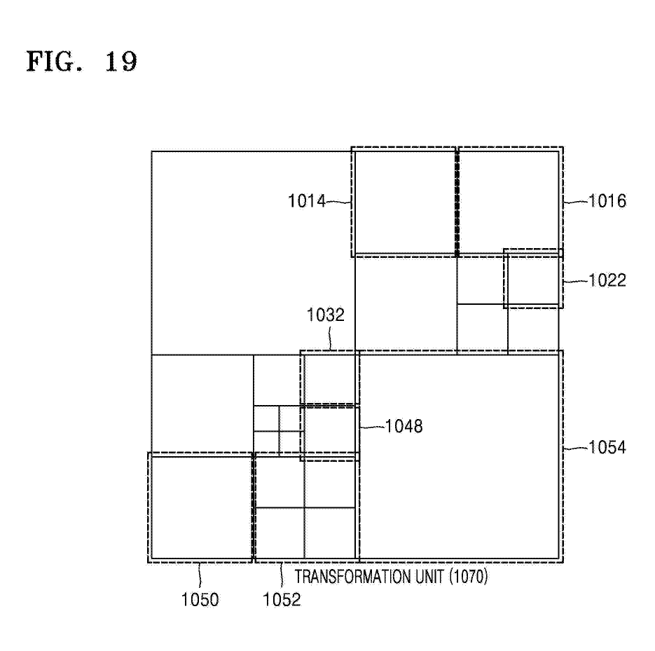

Referring to FIG. 19, the split information (TU size flag) is a flag having a value or 0 or 1, but the TU size flag according to some exemplar embodiments is not limited to 1 bit, and a transformation unit may be hierarchically split having a tree structure while the TU size flag increases from 0. Split information (TU size flag) of a transformation unit may be an example of a transformation index.

In this case, the size of a transformation unit that has been actually used may be expressed by using a TU size flag of a transformation unit, according to various embodiments, together with a maximum size and minimum size of the transformation unit. The video encoding apparatus 100 according to various embodiments is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 according to various embodiments may decode video by using the maximum transformation unit size information, the minimum transformation unit size information, and the maximum TU size flag.

For example, (a) if the size of a current coding unit is 64×64 and a maximum transformation unit size is 32×32, (a-1) then the size of a transformation unit may be 32×32 when a TU size flag is 0, (a-2) may be 16×16 when the TU size flag is 1, and (a-3) may be 8×8 when the TU size flag is 2.

As another example, (b) if the size of the current coding unit is 32×32 and a minimum transformation unit size is 32×32, (b-1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to various embodiments, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the present disclosure is not limited thereto.

According to the video encoding method based on coding units having a tree structure as described with reference to FIGS. 8 through 20, image data of a spatial region is encoded for each coding unit of a tree structure. According to the video decoding method based on coding units having a tree structure, decoding is performed for each largest coding unit to reconstruct image data of a spatial region. Thus, a picture and a video that is a picture sequence may be reconstructed. The reconstructed video may be reproduced by a reproducing apparatus, stored in a storage medium, or transmitted through a network.

The embodiments according to the present disclosure may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

For convenience of description, the multi-layer video encoding method and/or the video encoding method described above with reference to FIGS. 1A through 20 will be collectively referred to as a ‘video encoding method of the present disclosure’. In addition, the multi-layer video decoding method and/or the video decoding method described above with reference to FIGS. 1A through 20 will be referred to as a ‘video decoding method of the present disclosure’.

Also, a video encoding apparatus including the multi-layer video encoding apparatus 10, the video encoding apparatus 100, or the image encoder 400, which has been described with reference to FIGS. 1A through 20, will be referred to as a ‘video encoding apparatus of the present disclosure’. In addition, a video decoding apparatus including the multi-layer video decoding apparatus 20, the video decoding apparatus 200, or the image decoder 500, which has been descried with reference to FIGS. 1A through 20, will be collectively referred to as a ‘video decoding apparatus of the present disclosure’.

The computer-readable recording medium such as a disc 26000 that stores the program according to various embodiments will now be described in detail.

FIG. 21 is a diagram of a physical structure of the disc 26000 in which a program according to various embodiments is stored. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000 according to the various embodiments, a program that executes the quantization parameter determining method, the video encoding method, and the video decoding method described above may be assigned and stored.

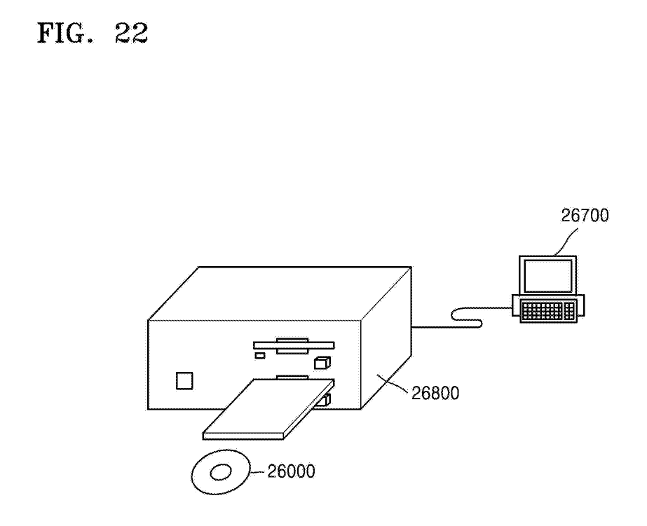

A computer system embodied using the storage medium that stores the program for executing the video encoding method and the video decoding method as described above will now be described with reference to FIG. 22.

FIG. 22 is a diagram of a disc drive 26800 for recording and reading a program by using the disc 26000. A computer system 26700 may store a program that executes at least one of a video encoding method and a video decoding method of the present disclosure, in the disc 26000 via the disc drive 26800. To run the program stored in the disc 26000 in the computer system 26700, the program may be read from the disc 26000 and be transmitted to the computer system 26700 by using the disc drive 26800.

The program that executes at least one of a video encoding method and a video decoding method of the present disclosure may be stored not only in the disc 26000 illustrated in FIG. 21 or 22 but also in a memory card, a ROM cassette, or a solid state drive (SSD).

A system to which the video encoding method and a video decoding method described above are applied will be described below.

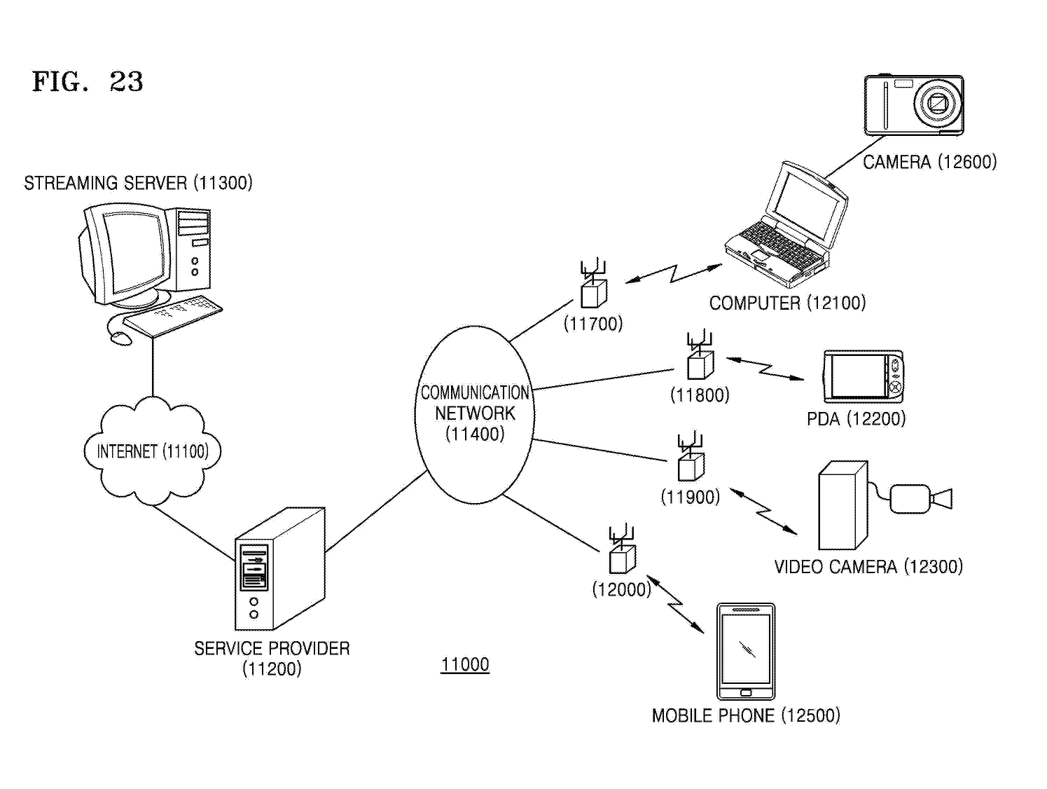

FIG. 23 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

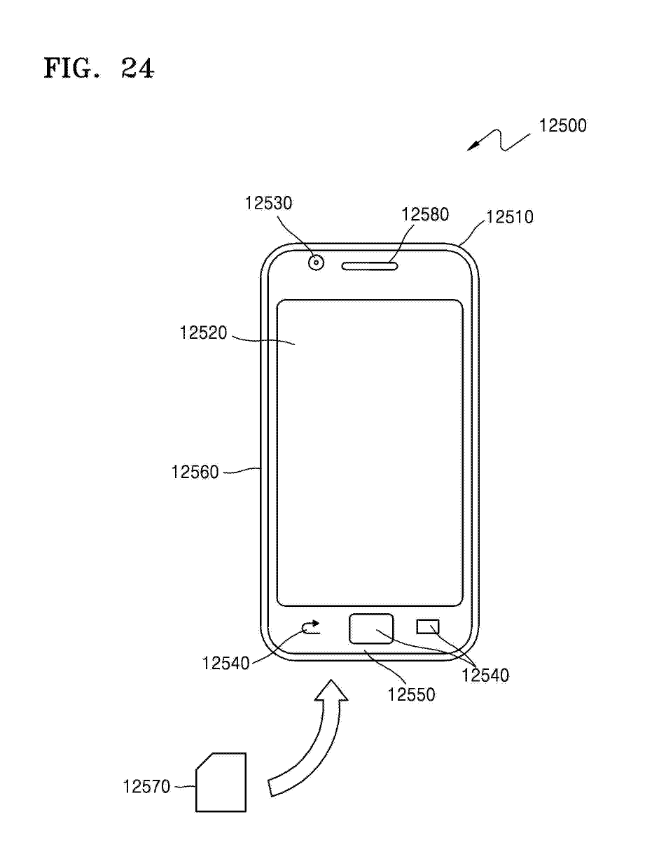

However, the content supply system 11000 is not limited to the structure as illustrated in FIG. 24, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded by the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 according to various embodiments may encode content data recorded by a user using the video camera 12300, the camera 12600, the mobile phone 12500, or another imaging device, e.g., content recorded during a concert, and may transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and to decode and reproduce the encoded content data in real-time, thereby enabling personal broadcasting.

The video encoding apparatus and the video decoding apparatus of the present disclosure may be applied to encoding and decoding operations of the plurality of independent devices included in the content supply system 11000.

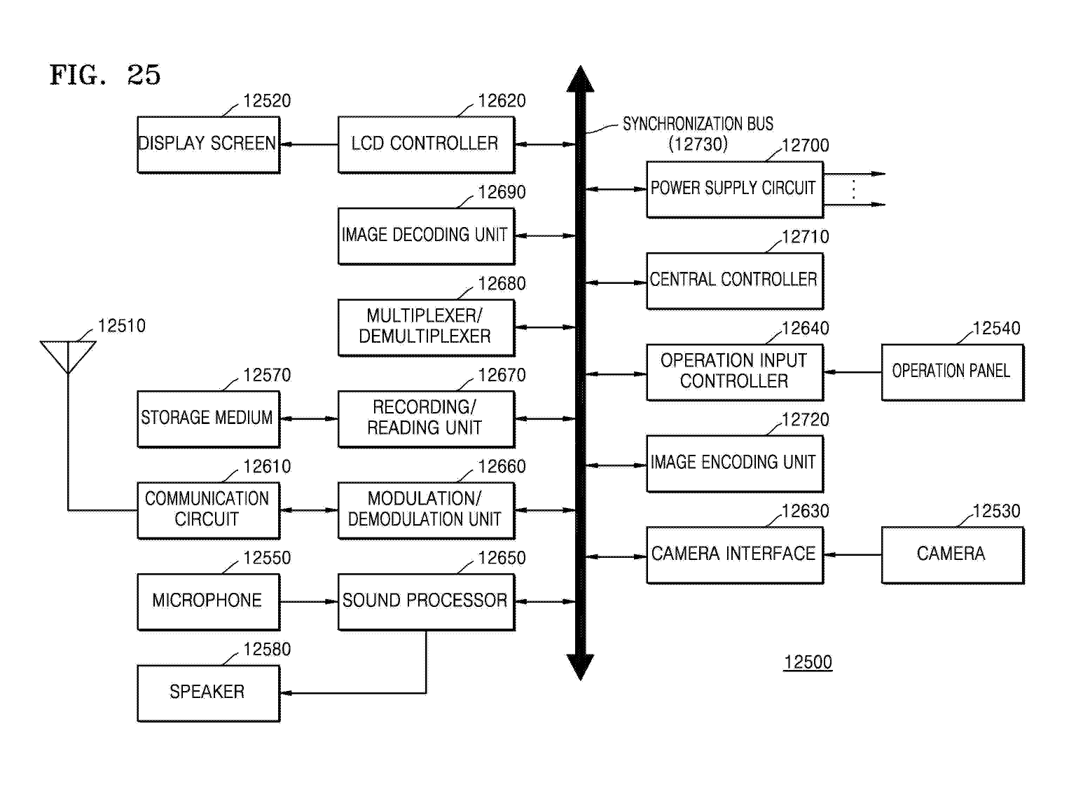

The mobile phone 12500 included in the content supply system 11000 according to an embodiment will now be described in greater detail with referring to FIGS. 24 and 25.

FIG. 24 illustrates an external structure of the mobile phone 12500 to which the video encoding method and the video decoding method of the present disclosure are applied, according to various embodiments. The mobile phone 12500 may be a smart phone, the functions of which are not limited and a large number of the functions of which may be changed or expanded via application programs.

The mobile phone 12500 includes an internal antenna 12510 via which a radio-frequency (RF) signal may be exchanged with the wireless base station 12000, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound output unit, and a microphone 12550 for inputting voice and sound or another type sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500. To systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 in an operation mode.

The central controller 12710 includes a central processing unit (CPU), ROM, and RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulation/demodulation unit 12660 under control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulation/demodulation unit 12660 and the communication circuit 12610, and may be transmitted via the antenna 12510.

When a text message, e.g., email, is transmitted in a data communication mode, text data of the text message is input via the operation panel 12540 and is transmitted to the central controller 12610 via the operation input controller 12640. Under control of the central controller 12610, the text data is transformed into a transmission signal via the modulation/demodulation unit 12660 and the communication circuit 12610 and is transmitted to the wireless base station 12000 via the antenna 12510.

To transmit image data in the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the video encoding apparatus of the present disclosure described above. The image encoder 12720 may transform the image data received from the camera 12530 into compressed and encoded image data according to the video encoding method described above, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulation/demodulation unit 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulation/demodulation unit 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoder 12690 may correspond to that of the video decoding apparatus of the present disclosure described above. The image decoder 12690 may decode the encoded video data to obtain reconstructed video data and provide the reconstructed video data to the display screen 12520 via the LCD controller 12620, according to a video decoding method described above.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both the video encoding apparatus and the video decoding apparatus of the present disclosure, may be a transmitting terminal including only the video encoding apparatus of the present disclosure, or may be a receiving terminal including only the video decoding apparatus of the present disclosure.

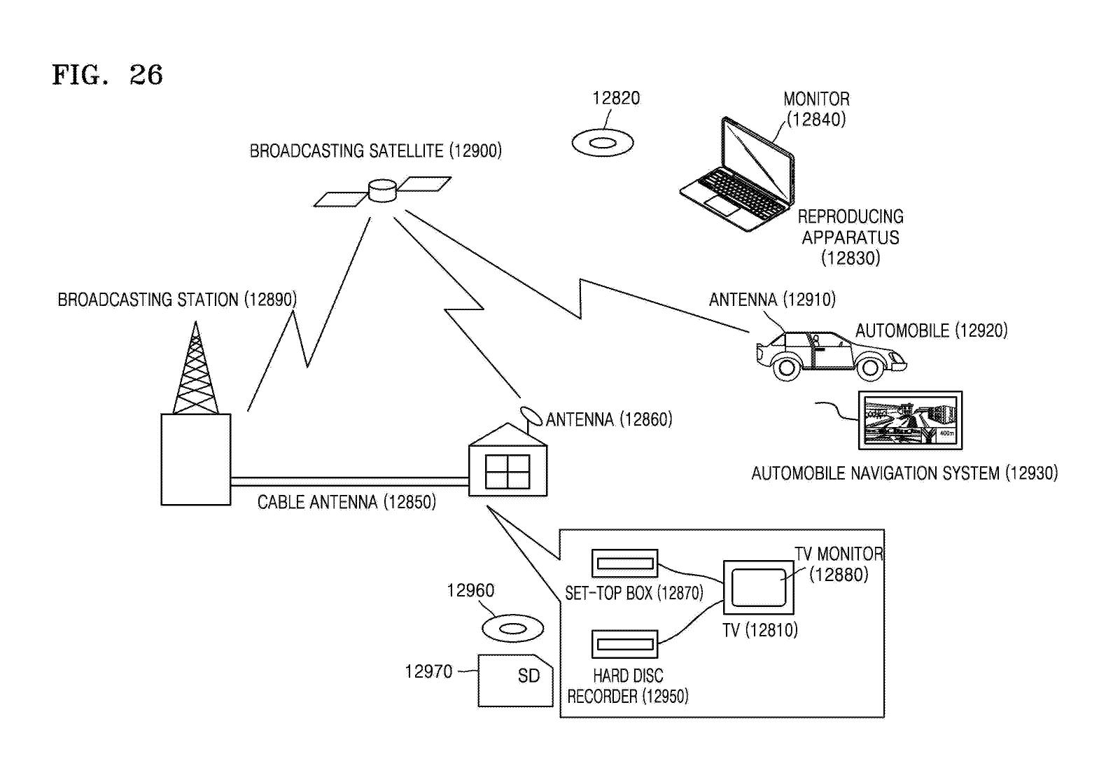

A communication system according to the present disclosure is not limited to the communication system described above with reference to FIG. 24. For example, FIG. 26 illustrates a digital broadcasting system employing a communication system, according to various embodiments. The digital broadcasting system of FIG. 26 according to various embodiments may receive a digital broadcast transmitted via a satellite or a terrestrial network by using the video encoding apparatus and the video decoding apparatus of the present disclosure.

In more detail, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When the video decoding apparatus of the present disclosure is implemented in a reproducing apparatus 12830, the reproducing apparatus 12830 may read and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, the video decoding apparatus of the present disclosure may be installed. Data output from the set-top box 12870 may also be reproduced on a TV monitor 12880.

As another example, the video decoding apparatus of the present disclosure may be installed in the TV receiver 12810 instead of the set-top box 12870.

An automobile 12920 that has an appropriate antenna 12910 may receive a signal transmitted from the satellite 12900 or the wireless base station 11700. A decoded video may be reproduced on a display screen of an automobile navigation system 12930 installed in the automobile 12920.

A video signal may be encoded by the video encoding apparatus of the present disclosure and may then be recorded to and stored in a storage medium. In more detail, an image signal may be stored in a DVD disc 12960 by a DVD recorder or may be stored in a hard disc by a hard disc recorder 12950. As another example, the video signal may be stored in an SD card 12970. If the hard disc recorder 12950 includes the video decoding apparatus of the present disclosure according to various embodiments, a video signal recorded on the DVD disc 12960, the SD card 12970, or another storage medium may be reproduced on the TV monitor 12880.

The automobile navigation system 12930 may not include the camera 12530, the camera interface 12630, and the image encoder 12720 of FIG. 26. For example, the computer 12100 and the TV receiver 12810 may not include the camera 12530, the camera interface 12630, and the image encoder 12720 of FIG. 26.

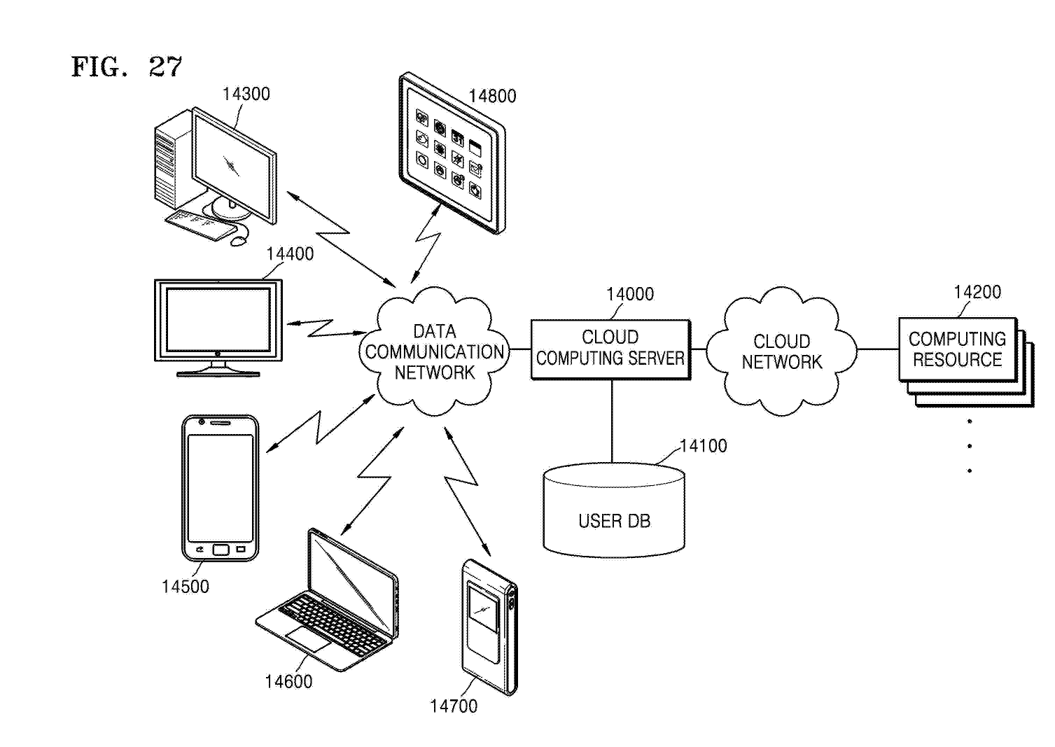

FIG. 27 is a diagram illustrating a network structure of a cloud computing system using a video encoding apparatus and a video decoding apparatus, according to various embodiments.

The cloud computing system may include a cloud computing server 14000, a user database (DB) 14100, computing resources 14200, and a user terminal.

The cloud computing system provides an on-demand outsourcing service of the plurality of computing resources via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include the video decoding apparatus of the present disclosure as described above with reference to FIGS. 1A through 20. As another example, the user terminal may include the video encoding apparatus of the present disclosure as described above with reference to FIGS. 1A through 20. Alternatively, the user terminal may include both the video decoding apparatus and the video encoding apparatus of the present disclosure as described above with reference to FIGS. 1A through 20.

Various applications of a video encoding method, a video decoding method, a video encoding apparatus, and a video decoding apparatus according to various embodiments described above with reference to FIGS. 1A through 20 have been described above with reference to FIGS. 21 through 27. However, methods of storing the video encoding method and the video decoding method in a storage medium or methods of implementing the video encoding apparatus and the video decoding apparatus in a device, according to various embodiments, are not limited to the embodiments described above with reference to FIGS. 21 through 27.

It will be understood by one of ordinary skill in the art that various changes in form and details may be made therein without departing from the spirit and scope of the invention as defined by the appended claims. The embodiments should be considered in a descriptive sense only and not for purposes of limitation. Therefore, the scope of the invention is defined not by the detailed description of the invention but by the appended claims, and all differences within the scope will be construed as being included in the present disclosure.

1. A multi-layer video decoding method comprising:
obtaining, from a bitstream, dependency information indicating whether a first layer refers to a second layer;
if the dependency information indicates that the first layer refers to the second layer, obtaining a reference picture set of the first layer, based on whether type information of the first layer and type information of the second layer are equal to each other; and
decoding encoded data of a current image included in the first layer, based on the reference picture set.

2. The multi-layer video decoding method of claim 1, wherein the type information of the first layer indicates whether an image included in the first layer is a depth image, and the type information of the second layer indicates whether an image included in the second layer is a depth image.

3. The multi-layer video decoding method of claim 1, wherein the obtaining of the reference picture set of the first layer comprises, if a value of the type information of the first layer and a value of the type information of the second layer are equal to each other, allowing pictures of the second layer to be included in the reference picture set of the first layer.

4. The multi-layer video decoding method of claim 1, wherein the decoding of the encoded data of the current image included in the first layer comprises performing disparity compensation based on the reference picture set.

5. The multi-layer video decoding method of claim 1, wherein the type information of the first layer and the type information of the second layer are obtained from the bitstream.

6. A multi-layer video encoding method comprising:
generating dependency information indicating whether a first layer refers to a second layer;
if the dependency information indicates that the first layer refers to the second layer, obtaining a reference picture set of the first layer based on whether type information of the first layer and type information of the second layer are equal to each other; and
encoding a current image included in the first layer, based on the reference picture set.

7. The multi-layer video encoding method of claim 6, wherein the type information of the first layer indicates whether an image included in the first layer is a depth image, and the type information of the second layer indicates whether an image included in the second layer is a depth image.

8. The multi-layer video encoding method of claim 6, wherein the obtaining of the reference picture set of the first layer comprises, if a value of the type information of the first layer and a value of the type information of the second layer are equal to each other, allowing pictures of the second layer to be included in the reference picture set of the first layer.

9. The multi-layer video encoding method of claim 6, wherein the encoding of the current image included in the first layer comprises performing disparity compensation based on the reference picture set.

10. The multi-layer video encoding method of claim 6, further comprising generating the type information of the first layer and the type information of the second layer.

11. A multi-layer video decoding apparatus comprising:
an obtainer for obtaining, from a bitstream, dependency information indicating whether a first layer refers to a second layer; and
a decoder, if the dependency information indicates that the first layer refers to the second layer, obtaining a reference picture set of the first layer, based on whether type information of the first layer and type information of the second layer are equal to each other, and decoding encoded data of a current image included in the first layer based on the reference picture set.

12. The multi-layer video decoding apparatus of claim 11, wherein the type information of the first layer indicates whether an image included in the first layer is a depth image, and the type information of the second layer indicates whether an image included in the second layer is a depth image.

13.-15. (canceled)
